(19) United States
(12) Patent Application Publication
(10) Pub. No.: US 2012/0306825 A1
(43) Pub. Date: Dec. 6, 2012

(54) DISPLAY DRIVER INTEGRATED CIRCUIT HAVING ZIGZAG SPREADING OUTPUT DRIVING SCHEME, DISPLAY DEVICE INCLUDING THE SAME AND METHOD OF DRIVING THE DISPLAY DEVICE

(76) Inventor: Young-Joon Cho, Gyeonggi-do (KR)

(21) Appl. No.: 13/477,315

(22) Filed: May 22, 2012

(30) Foreign Application Priority Data
May 30, 2011 (KR) 10-2011-0051674

(51) Int. Cl. G06F 3/038

(52) U.S. Cl. 345/204

(57) ABSTRACT

In one embodiment, the method includes storing data corresponding to each of the N data lines in response to a control signal; adjusting output timings of data corresponding to the respective N data lines in a zigzag spreading pattern; and outputting output signals based on the data to the N data lines according to the adjusted output timings.

### CROSS-REFERENCE TO RELATED APPLICATIONS

This application claims priority under 35 U.S.C. §119(a) from Korean Patent Application No. 10-2011-0051674 filed on May 30, 2011, the disclosure of which is hereby incorporated by reference in its entirety.

### BACKGROUND

The inventive concepts relate to a display device, and more particularly, to a display driver integrated circuit (IC) for driving a plurality of data lines, a method thereof and/or a display device including the same.

Instead of heavy and large cathode ray tube (CRT) display devices, flat display devices such as organic electroluminescence display (OLED) devices, plasma display panel (PDP) devices, and liquid crystal display (LCD) devices have come into the spotlight.

PDP devices display text or images using plasma generated by gas discharge. OLED devices display text or image using electroluminescence of particular organic materials or polymers. LCD devices display images by applying an electric field to a liquid crystal layer between two substrates and control the strength of the electric field to adjust the transmittance of light through the liquid crystal layer.

These flat display devices include a panel showing an image. The panel includes a plurality of pixels. The pixels are driven according to gray-level data provided by a display driver IC (DDI), so that the panel displays an image.

Conventionally, a DDI includes a grey-level voltage generation circuit which generates a plurality of (e.g., 64, 128 or 256) grey-level voltages and is configured to transmit the grey-level voltages from the gray-level voltage generation circuit to a channel driver, so that the channel driver selects one of the grey-level voltages according to digital image data and outputs the selected grey-level voltage to a corresponding data line. Such conventional DDI has a peak current occurring when an output current rapidly increases at the output timing of a data output driver since data signals are simultaneously output.

High peak current brings electromagnetic interference (EMI). EMI increases when the size of a display device increases since the number of output channels and the load of a data driver increase. High peak current also causes power consumption to increase and may affect a display panel, causing malfunction of a data driver.

### SUMMARY

According to some embodiments of the inventive concepts, there is provided a method of driving N data lines in a display device where N is 2 or an integer greater than 2 The method includes storing data corresponding to each of the N data lines in response to a control signal; adjusting output timings of data corresponding to the respective N data lines in a zigzag spreading pattern; and outputting output signals based on the data to the N data lines, respectively, according to the adjusted output timings.

Adjusting the output timings may include making an output timing for a first one of the N data lines lag behind an output timing for a k-th data line among the N data lines; and making an output timing for a second one of the N data lines lead the output timing for the k-th data line.

Here, a difference between an earliest output timing and a latest output timing for the N data lines may be within a desired, (or alternatively a predetermined) period of time.

The operation of adjusting the output timings may further include repeating changes in output timings to adjust the output timings for the N data lines in the zigzag pattern.

According to other embodiments of the inventive concepts, there is provided a display driver integrated circuit including a data storage block configured to store data corresponding to each of N data lines in a display device where N is 2 or an integer greater than 2; a spreading adjustment block configured to adjust output timings of data corresponding to the respective N data lines in a zigzag spreading pattern; and an output module configured to output output signals based on the data to the N data lines according to the adjusted output timings.

The data storage block may include N registers to receive and store the data in response to a control signal. The spreading adjustment block may include a spreading delay-cell array configured to adjust output timings of the registers in the zigzag pattern.

According to further embodiments of the inventive concepts, there is provided a display device including a display panel including N data lines, a plurality of gate lines and a plurality of pixels connected between the N data lines and the respective gate lines where N is 2 or an integer greater than 2; an output driver configured to drive the N data lines; a gate driver configured to gate the plurality of gate lines; and a control circuit configured to control the output driver and the gate driver.

The output driver may include a data storage block configured to store data corresponding to each of the N data lines; a spreading adjustment block configured to adjust output timings of data corresponding to the respective N data lines in a zigzag spreading pattern; and an output module configured to output output signals based on the data to the N data lines according to the adjusted output timings.

According to further embodiments of the inventive concepts, there is provided a display device including a display panel comprising N data lines, a plurality of gate lines and a plurality of pixels connected between the N data lines and the respective gate lines where N is 2 or an integer greater than 2; an output driver configured to drive the N data lines; a gate driver configured to gate the plurality of gate lines; and a control circuit configured to control the output driver and the gate driver.

The output driver comprises a data storage block configured to receive and store data corresponding to each of the N data lines; a spreading adjustment block configured to adjust output timings of data corresponding to the respective N data lines in a zigzag spreading pattern; and an output module configured to output output signals based on the data to the N data lines, respectively, according to the adjusted output timings.

The display device of may be a liquid crystal display (LCD) device or an organic light emitting diode (OLED) device.

According to further embodiments of the inventive concepts, there is provided a display device including a display panel comprising N data lines, a plurality of X scan lines, a plurality of Y scan lines and a plurality of pixels connected between the N data lines, the respective X scan lines and the respective Y scan lines where N is 2 or an integer greater than 2; an output driver configured to drive the N data lines; a X scan driver configured to scan the plurality of X scan lines; a Y scan driver configured to scan the plurality of Y scan lines; and a control circuit configured to control the output driver, the X scan driver and the Y scan driver.

The output driver comprises a data storage block configured to store data corresponding to each of the N data lines; a spreading adjustment block configured to adjust output timings of data corresponding to the respective N data lines in a zigzag spreading pattern; and an output module configured to output output signals based on the data corresponding to the N data lines according to the adjusted output timings.

The display device may be a plasma display device.

According to yet further embodiments of the inventive concepts, there is provided an output driver comprising a data storage block configured to store data from data lines in the output driver, a spreading adjustment block configured to adjust output timing of data corresponding to the data lines, in a zig-zag pattern.

The data storage block according to this embodiment may be a register array including a plurality of registers.

The zig-zag pattern of this embodiment may be defined by a lag time of L*td and a lead time of M*td, wherein L and M are natural numbers, L-M is greater than or equal to 1, and td is a unit time interval.

The spreading block may be a spreading delay cell array and the spreading delay cell array may comprise a unit delay element in parallel with fuses, and the fuses may originally in a disconnected state and are configured to be connected by application of a current. The spreading delay cell array may further comprise a unit delay element in parallel with switches.

### BRIEF DESCRIPTION OF THE DRAWINGS

The above and other features and advantages of the inventive concepts will become more apparent by describing in detail exemplary embodiments thereof with reference to the attached drawings in which:

FIG. 1A is a block diagram of a display device according to some embodiments of the inventive concepts;

FIG. 1B is a circuit diagram of a pixel when a display panel illustrated in FIG. 1A is a thin film transistor liquid crystal display (TFT-LCD) panel;

FIG. 1C is a circuit diagram of a pixel when the display panel illustrated in FIG. 1A is an organic light emitting diode (OLED) panel;

FIG. 1D is a block diagram of a plasma display device according to some embodiments of the inventive concepts;

FIG. 2 is a block diagram of an output driver according to some embodiments of the inventive concepts;

FIG. 3 is a block diagram showing in detail a register array and a spreading delay-cell array illustrated in FIG. 2;

FIG. 4 is a diagram showing an example of a delay cell illustrated in FIG. 3;

FIG. 5 is a block diagram of an output driver according to other embodiments of the inventive concepts;

FIG. 6 is a diagram showing in detail a register array and a spreading delay-cell array illustrated in FIG. 5;

FIGS. 7A through 7D are circuit diagrams of a delay cell included in the spreading delay-cell array illustrated in FIG. 6 according to different embodiments of the inventive concepts;

FIG. 8A is a diagram for explaining a zigzag spreading output driving scheme of an output driver according to some embodiments of the inventive concepts;

FIG. 8B shows output timings for data lines to explain a conventional simultaneous switching scheme;

FIG. 8C shows output timings for data lines to explain a sequential spreading output driving scheme as a comparison example;

FIG. 8D shows output timings for data lines to explain a zigzag spreading output driving scheme according to some embodiments of the inventive concepts;

FIGS. 9A through 9C are diagrams for comparing peak current in the simultaneous switching scheme, peak current in the sequential spreading output driving scheme, and peak current in the zigzag spreading output driving scheme with one another;

FIG. 10 is a data line-time graph showing the output timings for data lines in a zigzag spreading output scheme according to some embodiments of the inventive concepts;

FIG. 11 is a data line-time graph showing the output timings for data lines in a zigzag spreading output scheme according to other embodiments of the inventive concepts;

FIG. 12 is a data line-time graph showing the output timings for data lines in a zigzag spreading output scheme according to further embodiments of the inventive concepts;

FIG. 13 is a data line-time graph showing the output timings for data lines in a zigzag spreading output scheme according to other embodiments of the inventive concepts;

FIG. 14 is a block diagram of an output driver according to other embodiments of the inventive concepts;

FIG. 15 is a block diagram of an output driver according to further embodiments of the inventive concepts;

FIG. 16 is a block diagram of an output driver according to other embodiments of the inventive concepts;

FIG. 17 is a flowchart of a method of driving a display device according to some embodiments of the inventive concepts;

FIG. 18 is a flowchart of a method of driving a display device according to other embodiments of the inventive concepts;

FIG. 19 is a block diagram of an electronic system including a display device according to some embodiments of the inventive concepts;

FIG. 20 is a block diagram of an electronic system including a display device according to some embodiments of the inventive concepts; and

FIG. 21 is a block diagram of an electronic system including a display device according to other embodiments of the inventive concepts.

### DETAILED DESCRIPTION OF THE EMBODIMENTS

The inventive concepts now will be described more fully hereinafter with reference to the accompanying drawings, in which multiple embodiments are shown. The inventive concepts be embodied in many different forms and should not be construed as limited to the embodiments set forth herein. Rather, these embodiments are provided so that this disclosure will be thorough and complete, and will fully convey the scope of the inventive concepts to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which these inventive concepts belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

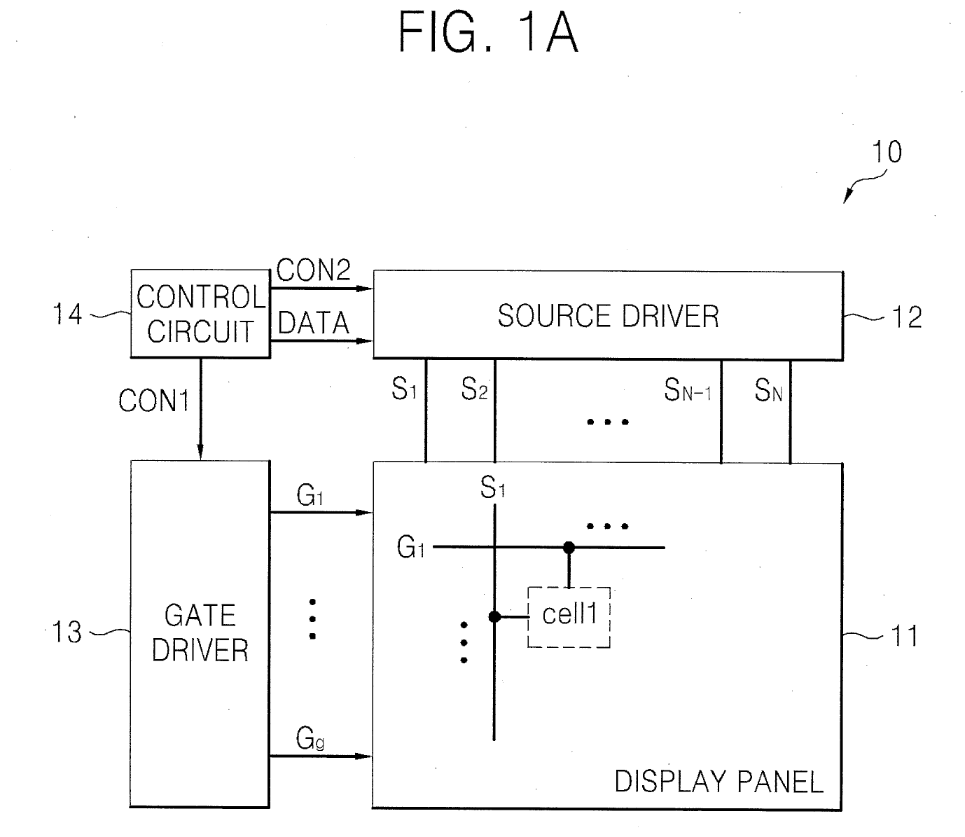

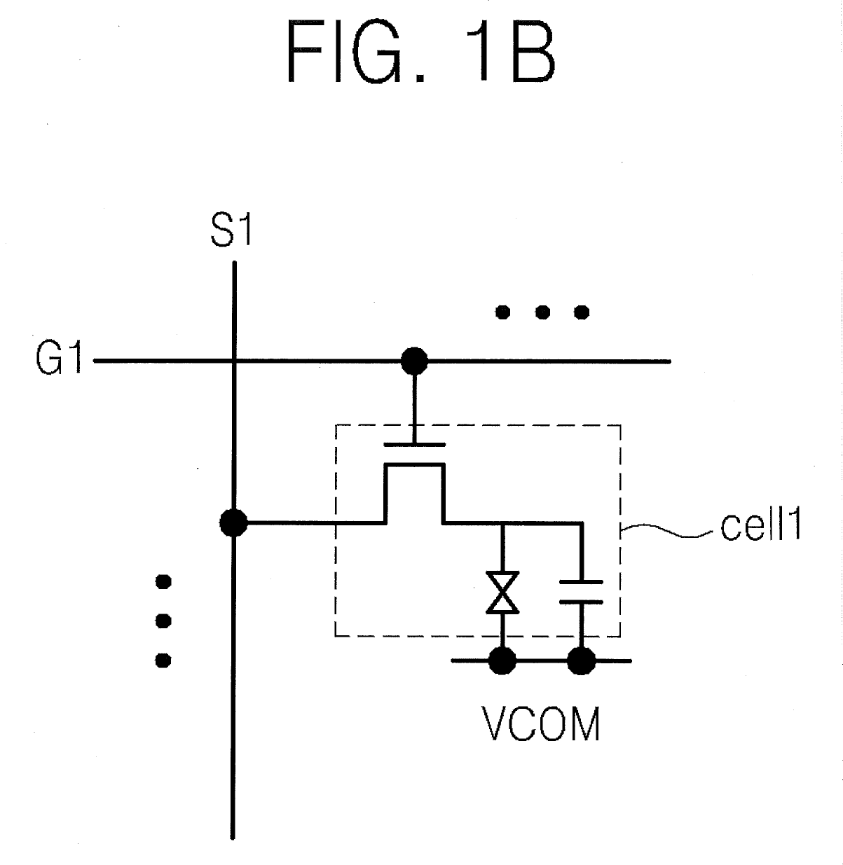

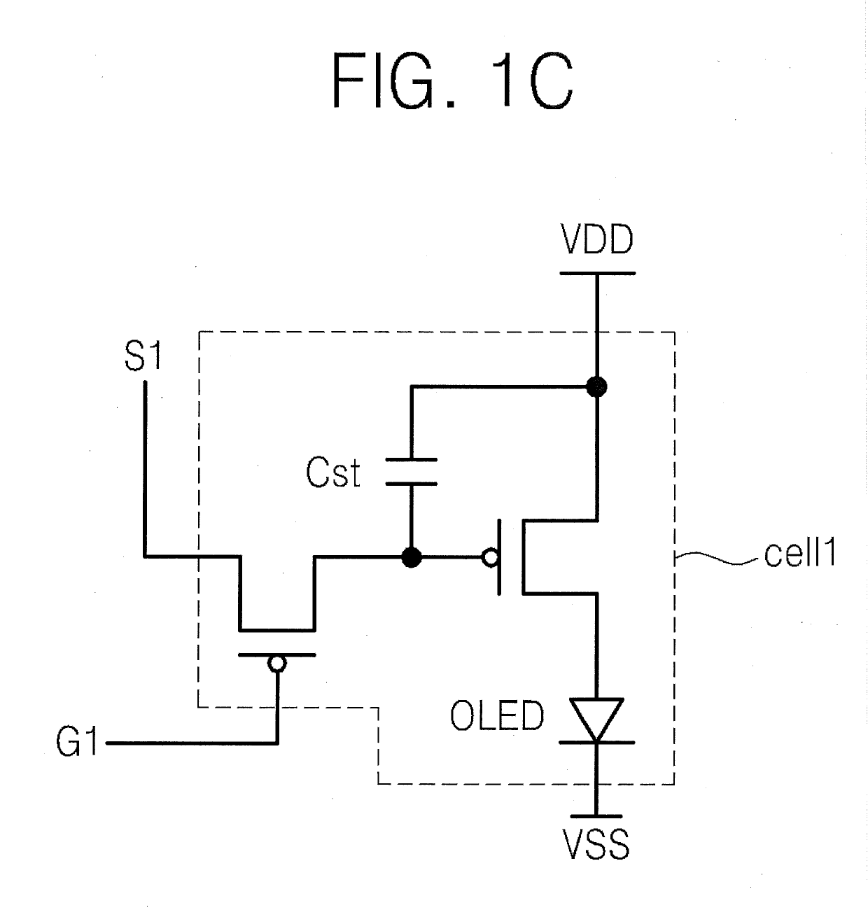

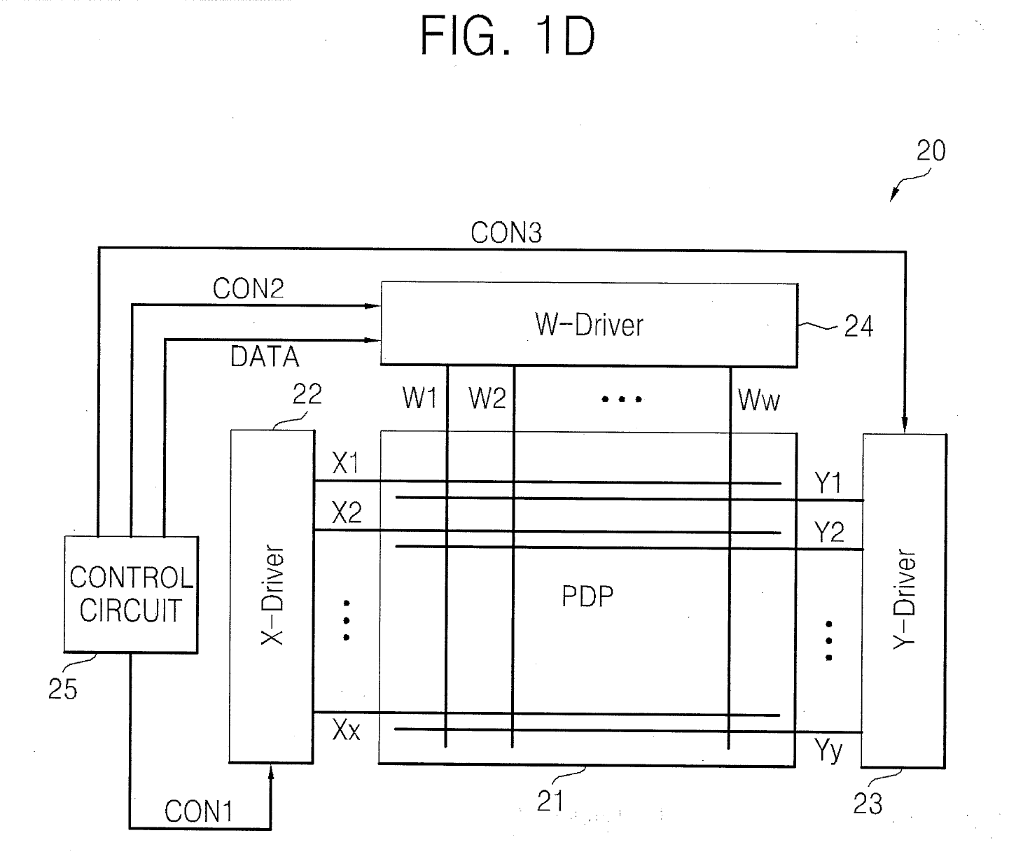

FIG. 1A is a block diagram of a display device 10 according to some embodiments of the inventive concepts. FIG. 1B is a circuit diagram of a pixel when a display panel 11, illustrated in FIG. 1A, is a thin-film-transistor liquid crystal display (TFT-LCD) panel. FIG. 1C is a circuit diagram of a pixel when the display panel 11 illustrated in FIG. 1A is an organic light emitting diode (OLED) panel.

Referring to FIG. 1A, the display device 10 includes the display panel 11, a control circuit 14, a gate driver 13, and a source driver 12.

The display panel 11 includes a plurality of source lines S₁ through S_{N} where “N” is a natural number, a plurality of gate lines G₁ through G_{g} where “g” is a natural number and g=N or g≠N, and a plurality of pixels including a unit pixel cell 1. Each of the pixels is connected between one of the source lines S₁ through S_{N} and one of the gate lines G₁ through G_{g}.

The display panel 11 may be a flat display panel such as a TFT-LCD panel, a plasma display panel (PDP), a light emitting diode (LED) panel, or an OLED panel, but the inventive concepts are not restricted to current examples.

The unit pixel cell 1 has the structure illustrated in FIG. 1B when the display panel 11 is a TFT-LCD panel and the structure illustrated in FIG. 1C when the display panel 11 is an OLED panel, but the inventive concepts are not restricted to the current embodiments.

The control circuit 14 generates a plurality of control signals including a first control signal CON1 and a second control signal CON2. For instance, the control circuit 14 may generate the first control signal CON1, the second control signal CON2, and image data DATA based on a horizontal synchronization signal and a vertical synchronization signal.

The gate driver 13 drives the gate lines G₁ through G_{g} sequentially in response to the first control signal CON1. The first control signal CON1 may be an indicator instructing to start the scanning of the gate lines G₁ through G_{g}.

The source driver 12 drives the source lines S₁ through S_{N} in response to the second control signal CON2 and the digital image data DATA, which are output from the control circuit 14. The source lines S₁ through S_{N} are also referred to as data lines. A driver for driving a single data line is referred to as a channel driver.

FIG. 1D is a block diagram of a display device 20 according to some embodiments of the inventive concepts. The display device 20 may be a plasma display device.

Referring to FIG. 1D, the display device 20 includes a plasma display panel (PDP) 21, a control circuit 25, an X-driver 22, a Y-driver 23, and a W-driver (an address driver or a data driver) 24. The PDP 21 may include a plurality of data lines W1 through W_{w}, a plurality of X scan lines (or X electrodes) X1 through Xₓ, a plurality of Y scan lines (or Y electrodes) Y1 through Y_{y} and a plurality of pixels. The plurality of pixels are connected between the N data lines, the respective X scan lines and the respective Y scan lines. N is 2 or an integer greater than 2.

The PDP 21 discharges light by controlling a voltage applied between a vertical electrode and a horizontal electrode of a cell forming a pixel and adjusts the quantity of the discharged light by changing the length of discharge time in the cell. The PDP 21 displays an entire image by driving cells in a matrix form by applying a write pulse for inputting a digital image signal, a scan pulse for scanning, a sustain pulse for sustaining a discharge, and an erase pulse for stopping the discharge of a cell to the vertical and the horizontal electrodes of each of the cells. In other words, a driving pulse from the X-driver 22 is applied to a plurality of X electrodes, i.e., scan electrodes X1 through Xₓ; data from the W-driver 24 is applied to a plurality of data lines (or address electrodes) W1 through W_{w}; and a common voltage from the Y-driver 23 is applied to Y electrodes Y1 through Y_{y} connected in common.

The control circuit 25 generates a plurality of control signals including a first control signal CON1, a second control signal CON2, and a third control signal CON3. For instance, the control circuit 25 may generate the first control signal CON1, the second control signal CON2, the third control signal CON3, and data DATA based on a horizontal synchronization signal and a vertical synchronization signal. The drivers 22, 24 and 23 are driven by the first through third control signals CON1, CON2, and CON3, respectively. A field is divided into a plurality of (e.g., 8) subfields. Each of the subfields is divided into a reset period, an address period, and a sustain period. At this time, three discharges, i.e., a full write discharge, a full sustain discharge and a full erase discharge occur during the reset period.

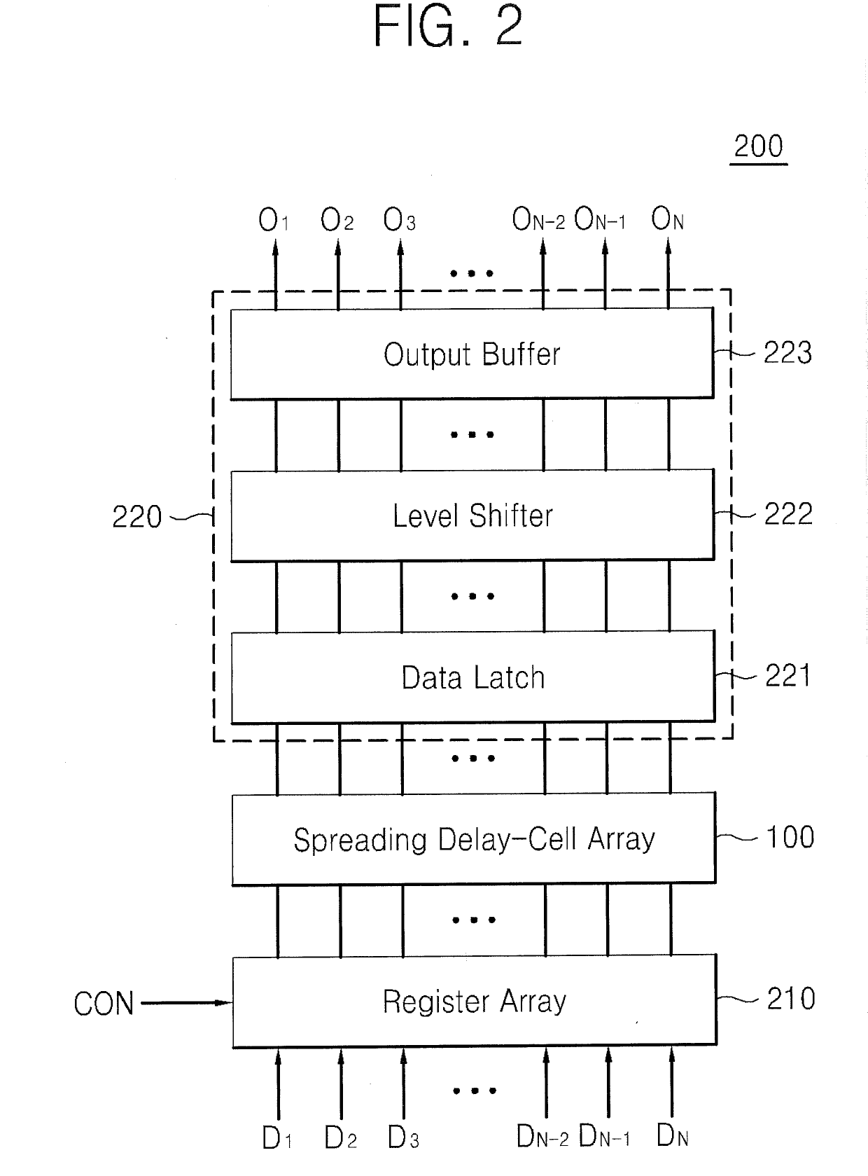

FIG. 2 is a block diagram of an output driver 200 according to some embodiments of the inventive concepts.

Referring to FIG. 2, the output driver 200 may include a data storage block 210, a spreading adjustment block, implemented as spreading delay cell array 100, and an output module 220. The data storage block 210 is a functional block that receives and stores data corresponding to each of N (N is 2 or an integer greater than 2) data lines O₁ through O_{N} of a display device and may be implemented by a register array including a plurality of registers. The spreading delay cell array 100 is an exemplary implementation of a spreading adjustment block, A spreading adjustment block is a functional block that adjusts the output timings of data corresponding to the data lines O₁ through O_{N} in a zigzag spreading pattern. The output module 220 outputs an output signal based on data to each of the data lines O₁ through O_{N} according to the adjusted output timing.

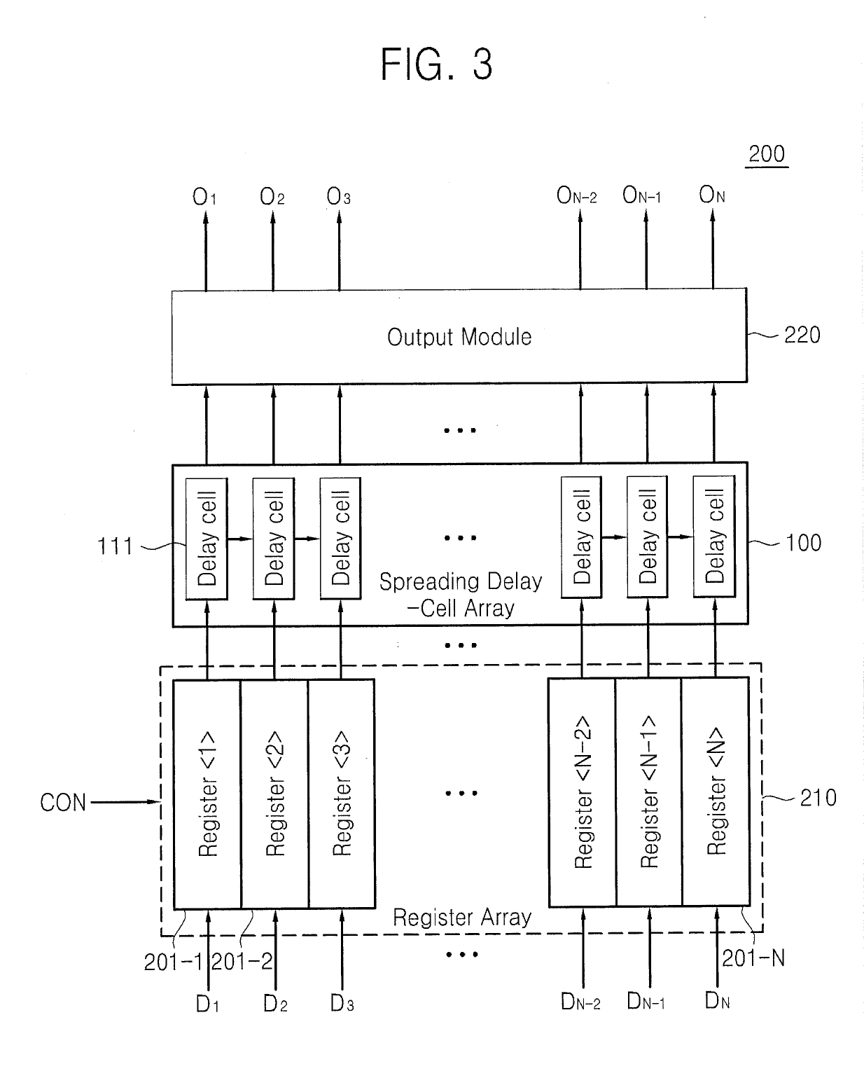

The output driver 200 may correspond to a source driver 12 illustrated in FIG. 1A or the W-driver 24 illustrated in FIG. 1D and may be implemented as an integrated circuit (IC). FIG. 3 is a block diagram showing the register array 210 and the spreading delay-cell array 100 illustrated in FIG. 2 in detail.

The register array 210 receives and stores data D₁ through D_{N} in arrays Register<1> through Register<N>, respectively, in response to a control signal CON generated by the control circuit 25. For instance, data D_{K} corresponding to the K-th data line O_{K} among the N data lines O₁ through O_{N} is stored in the K-th array Register<K>. Here, N is 2 or an integer greater than 2 and K is any integer from 1 to N.

The spreading delay-cell array 100 is connected with all output lines of the register array 210 and adjusts the output timings of data respectively stored in the arrays Register<1> through Register<N> to be in a zigzag pattern. Referring to FIG. 3, the spreading delay-cell array 100 includes a plurality of delay cells 111, e.g., as many delay cells as the number of channels. The delay cells 111 are respectively connected with the data lines O₁ through O_{N} and adjust the output timings therefor. Each of the delay cells 111 may include at least one buffer, an inverter, a transistor and/or a switching element, but the inventive concepts are not restricted thereto.

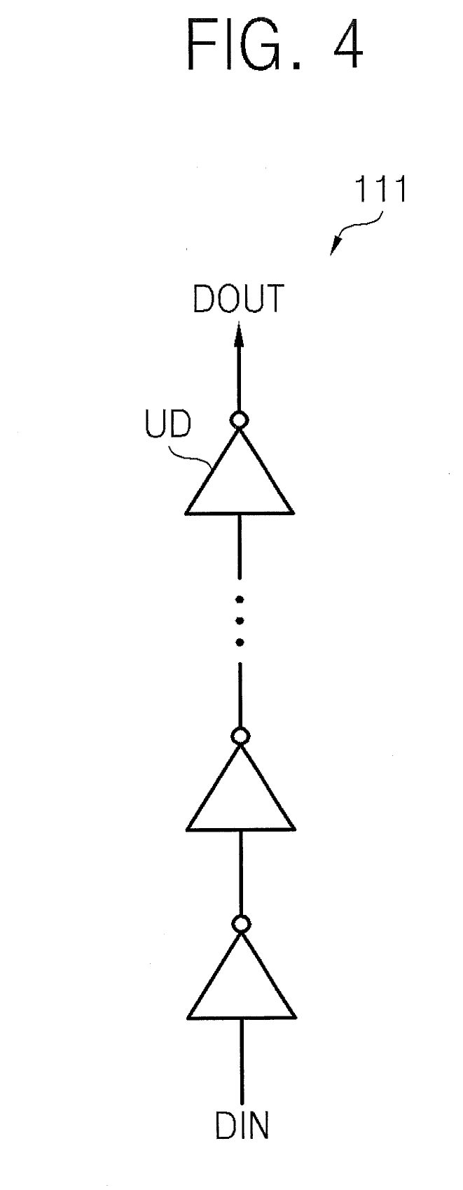

FIG. 4 is a diagram showing an example of a delay cell 111 illustrated in FIG. 3. The delay cell 111 may be embodied by connecting at least one unit delay element UD having a desired, (or alternatively a predetermined) delay time in series to each other. At this time, the output timing of a data line can be adjusted by adjusting the number of unit delay elements UD included in the delay cell 111. The number of unit delay elements UD included in the delay cell 111 may be predetermined.

The operation of the spreading delay-cell array 100 will be described in detail with reference to FIGS. 4 through 8D later.

The output module 220 outputs data stored in each array to a corresponding data line according to the adjusted output timing. The output module 220 may include a latch circuit 221, a level shifter 222, and an output buffer 223.

The latch circuit 221 latches and outputs the output signals of the data lines O₁ through O_{N} to the level shifter 222. The level shifter 222 shifts the levels of the latched output signals. The output buffer 223 outputs the shifted output signals to the data lines O₁ through O_{N}, respectively.

Each output signal of the output module 220 may be a level signal corresponding to one of the data lines O₁ through O_{N} among a plurality of level signals. In other words, each output signal corresponds to a level of brightness, i.e., a grey level needed for image display and may be a level signal corresponding to one of a plurality of levels into which a desired, (or alternatively a predetermined) time or voltage given for displaying an entire image is divided.

For instance, for high-definition television (HDTV) 256 grey levels and a resolution of at least 1280×1024 are needed and a contrast of at least 100:1 is needed under a 200-lux light.

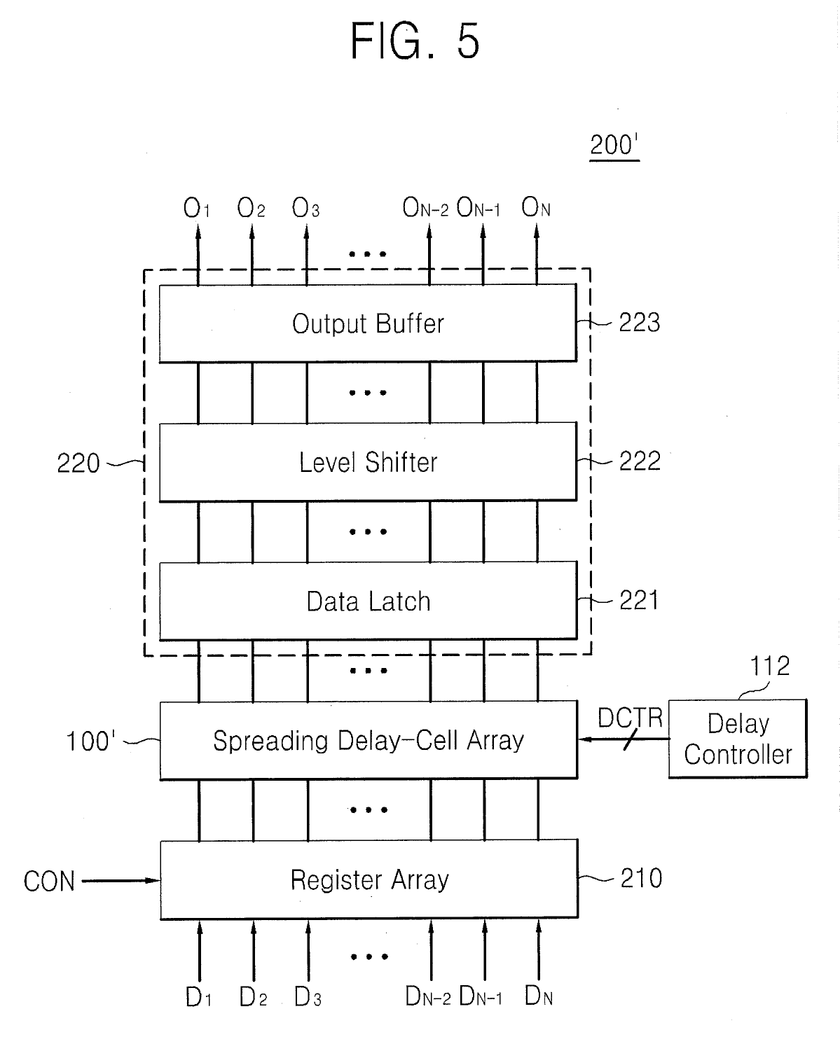

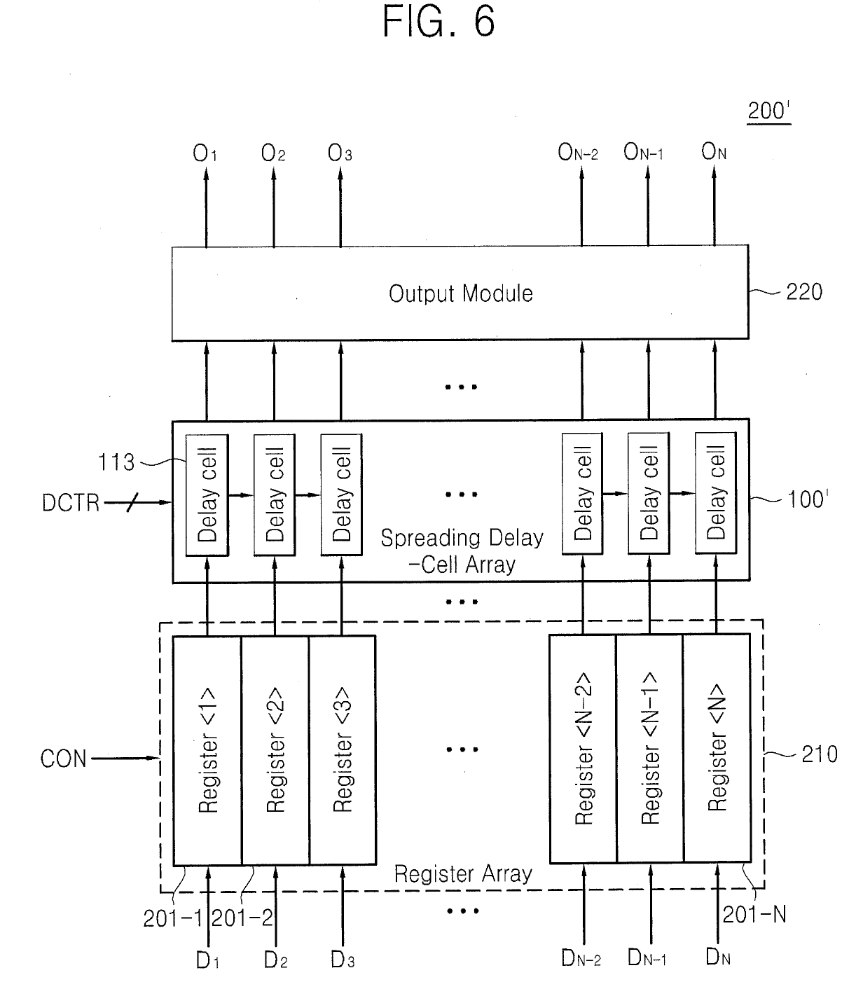

FIG. 5 is a block diagram of an output driver 200′ according to other embodiments of the inventive concepts. FIG. 6 is a diagram showing in detail the register array 210 and a spreading delay-cell array 100′ illustrated in FIG. 5. Since the embodiments illustrated in FIGS. 5 and 6 are similar to those illustrated in FIGS. 2 and 3, difference therebetween will be described to avoid redundancy.

As compared to the output driver 200 illustrated in FIG. 2, the output driver 200′ illustrated in FIG. 5 further includes a delay controller 112. The delay controller 112 generates a delay control signal DCTR for controlling a delay time of delay cells 113 included in the spreading delay-cell array 100′ for respective channels.

The delay time of each delay cell 113 of the spreading delay-cell array 100′ is adjusted in response to the delay control signal DCTR generated by the delay controller 112.

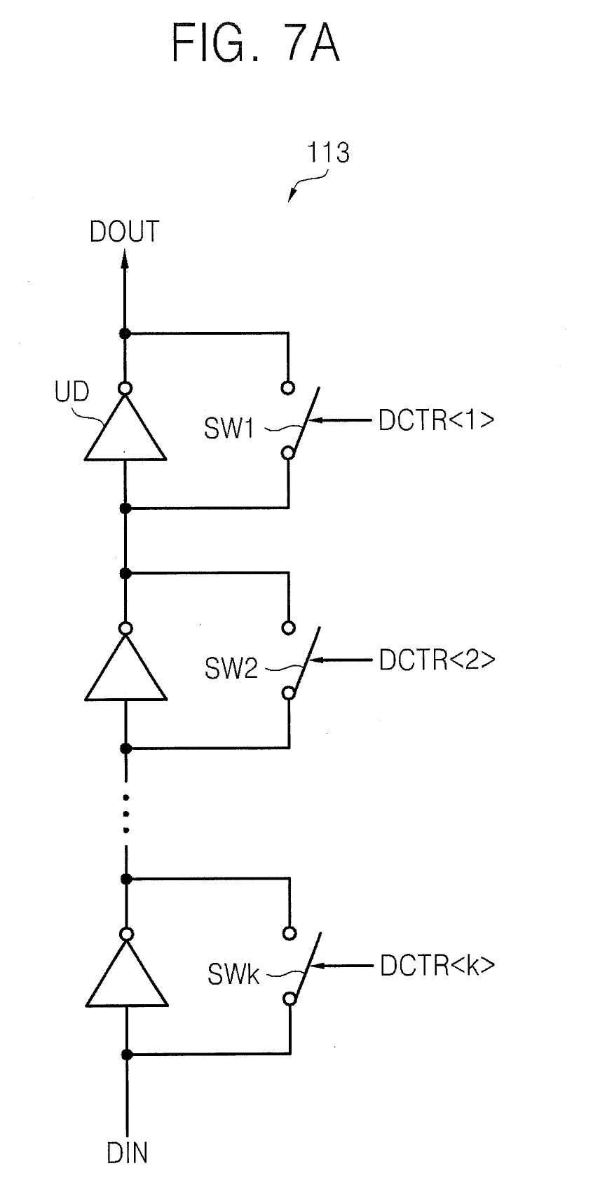

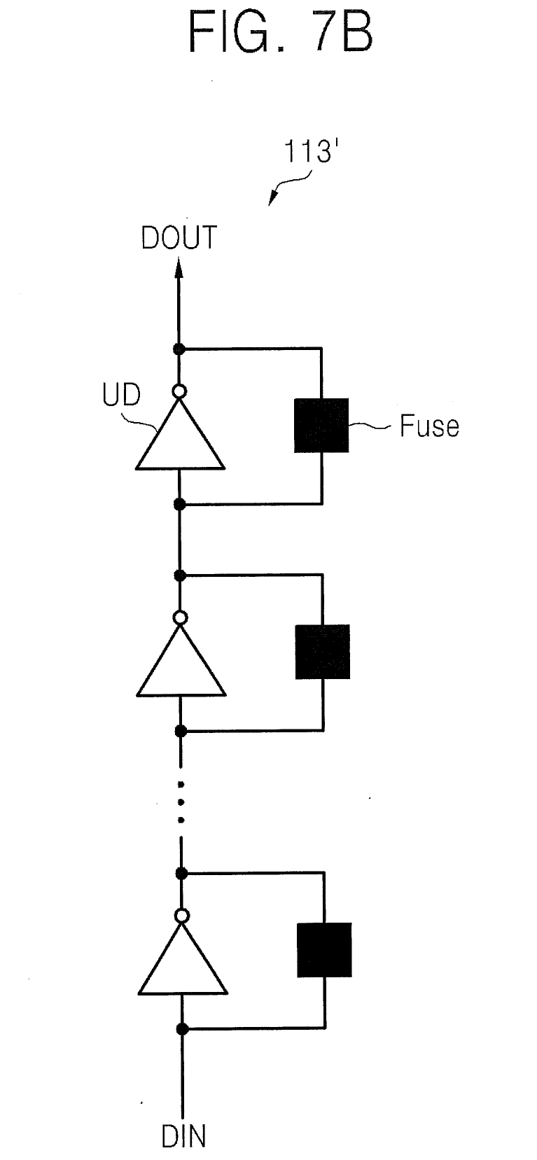

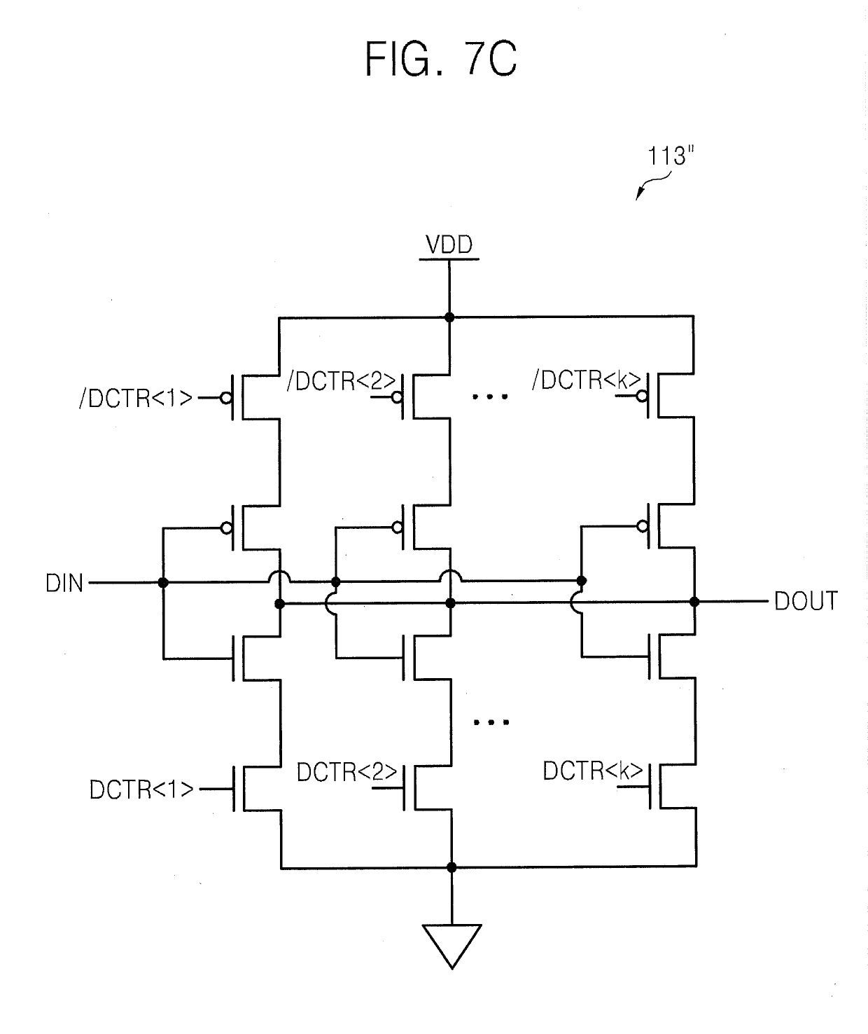

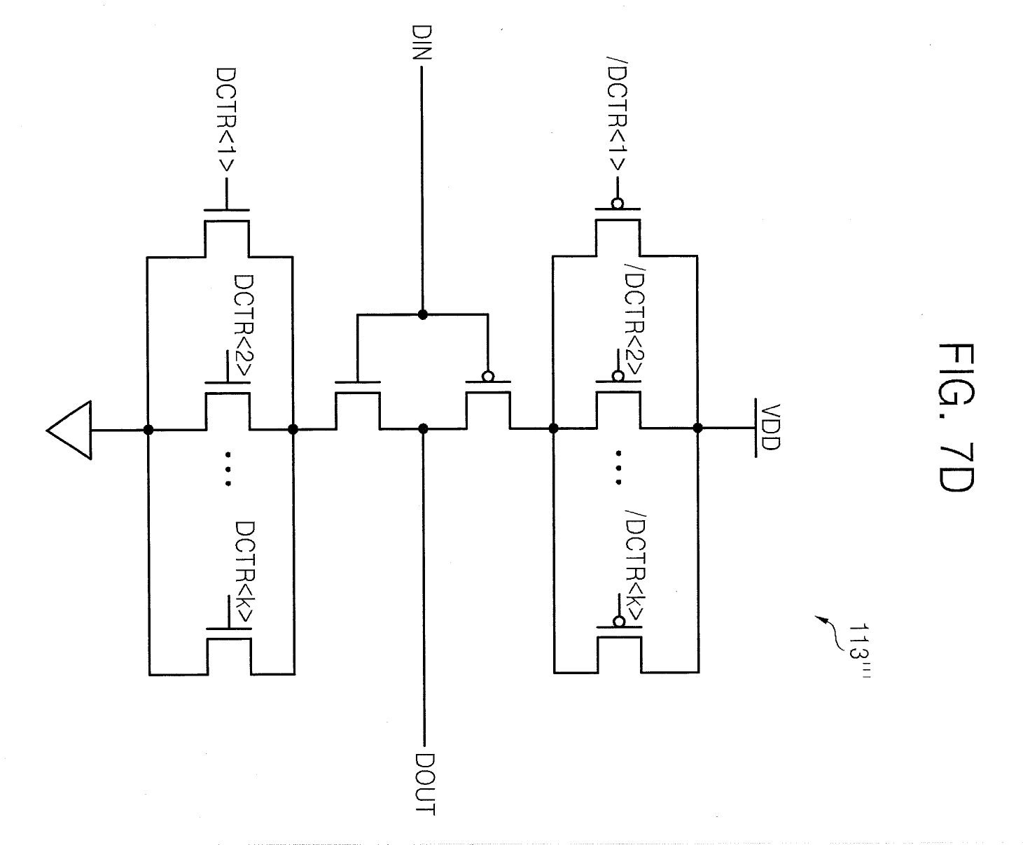

FIGS. 7A through 7D are circuit diagrams of a delay cell 113 included in the spreading delay-cell array 100′ illustrated in FIG. 6 according to different embodiments of the inventive concepts. In FIGS. 7A through 7D, DIN denotes an input signal of the delay cell 113 and DOUT denotes an output signal of the delay cell 113.

Referring to FIG. 7A, the delay cell 113 may include one or more unit delay elements UD connected in series and one or more switches SW1 through SWk respectively connected in parallel with the unit delay elements UD. The switches SW1 through SWk may be closed or opened in response to delay control signals DCTR<1> through DCTR<k>, respectively. The number of valid unit delay elements UD is changed according to the closing or opening of the switches SW1 through SWk. The switches SW1 through SWk are initially in an open state. If two of the switches SW1 through SWk are closed in response to the delay control signals DCTR<1> through DCTR<k>, even when the number of unit delay elements UD physically included in the delay cell 113 is L, the number of valid unit delay elements UD is (L-2). When the number of valid unit delay elements UD is adjusted for each channel, zigzag spreading output is accomplished.

A delay cell 113′ illustrated in FIG. 7B may include fuses instead of the switches SW1 through SWk illustrated in FIG. 7A. The delay cell 113′ may include one or more unit delay elements UD connected in series and one or more fuses respectively connected in parallel with the unit delay elements UD. The number of valid unit delay elements UD is changed according to the connection or disconnection of the fuses. When the number of valid unit delay elements UD is adjusted by cutting the fuses for each channel, zigzag spreading output is accomplished. The fuses may be initially in a connected state and may be cut off afterwards, but the inventive concepts are not restricted thereto. For instance, the fuses may be initially in a disconnected state and may be connected through conduction of current afterwards.

Delay cells 113″ and 113′″ illustrated in FIGS. 7C and 7D may include inverters which change a delay time in response to the delay control signals DCTR<1> through DCTR<k>.

Referring to FIGS. 7C and 7D, when the number of bits having a high level (e.g., logic 1) among the delay control signals DCTR<1> through DCTR<k> increases, the delay time may decrease. When the number of bits having a low level (e.g., logic 0) among the delay control signals DCTR<1> through DCTR<k> increases, the delay time may increase.

As described above, to provide zigzag spreading output, a delay cell for a channel may be configured to have a desired, (or alternatively a predetermined) fixed delay time or may be set to have a particular delay time using delay control signals in a configuration in which the delay cell has a variable delay time.

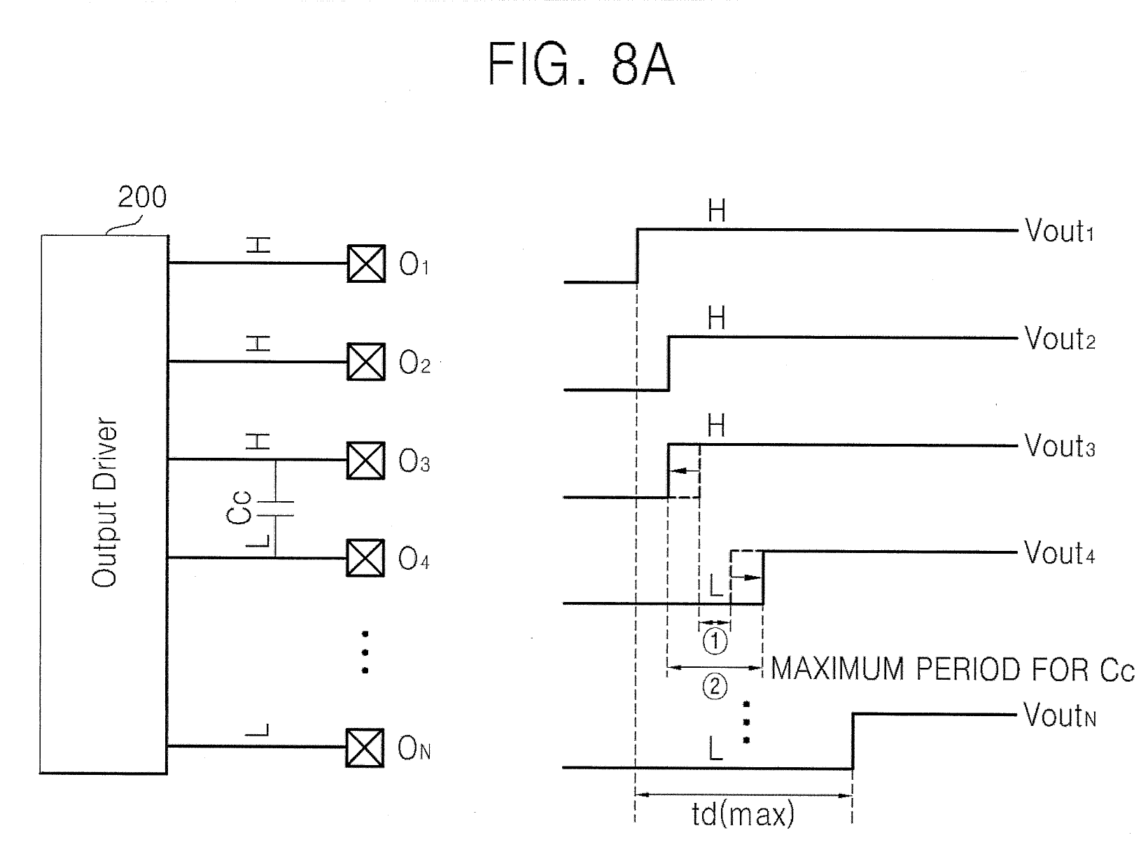

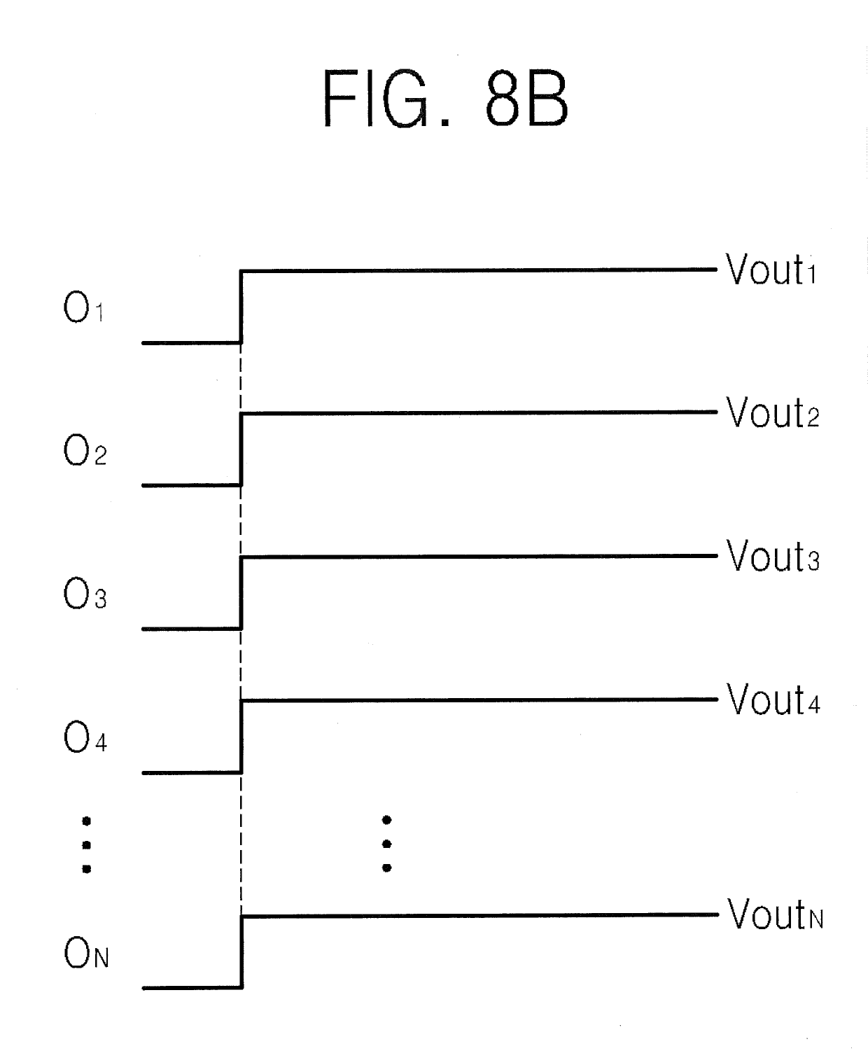

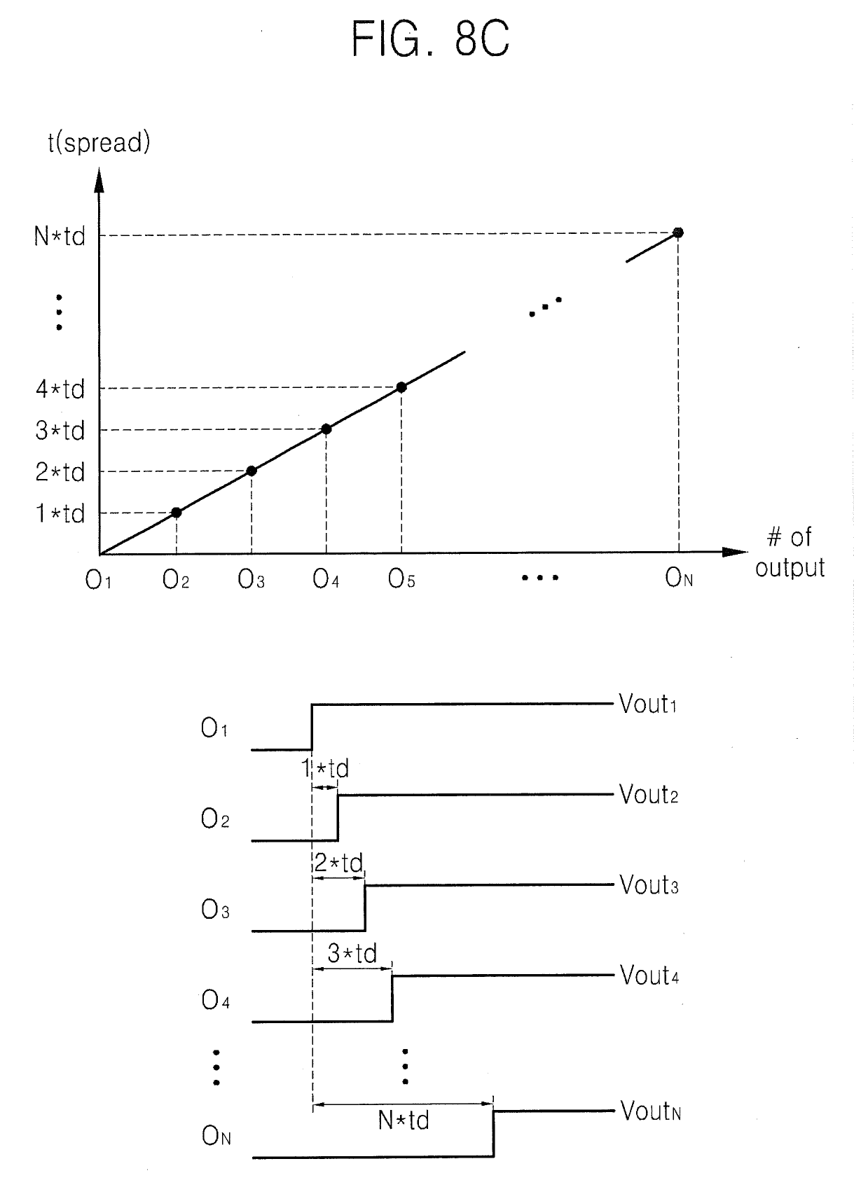

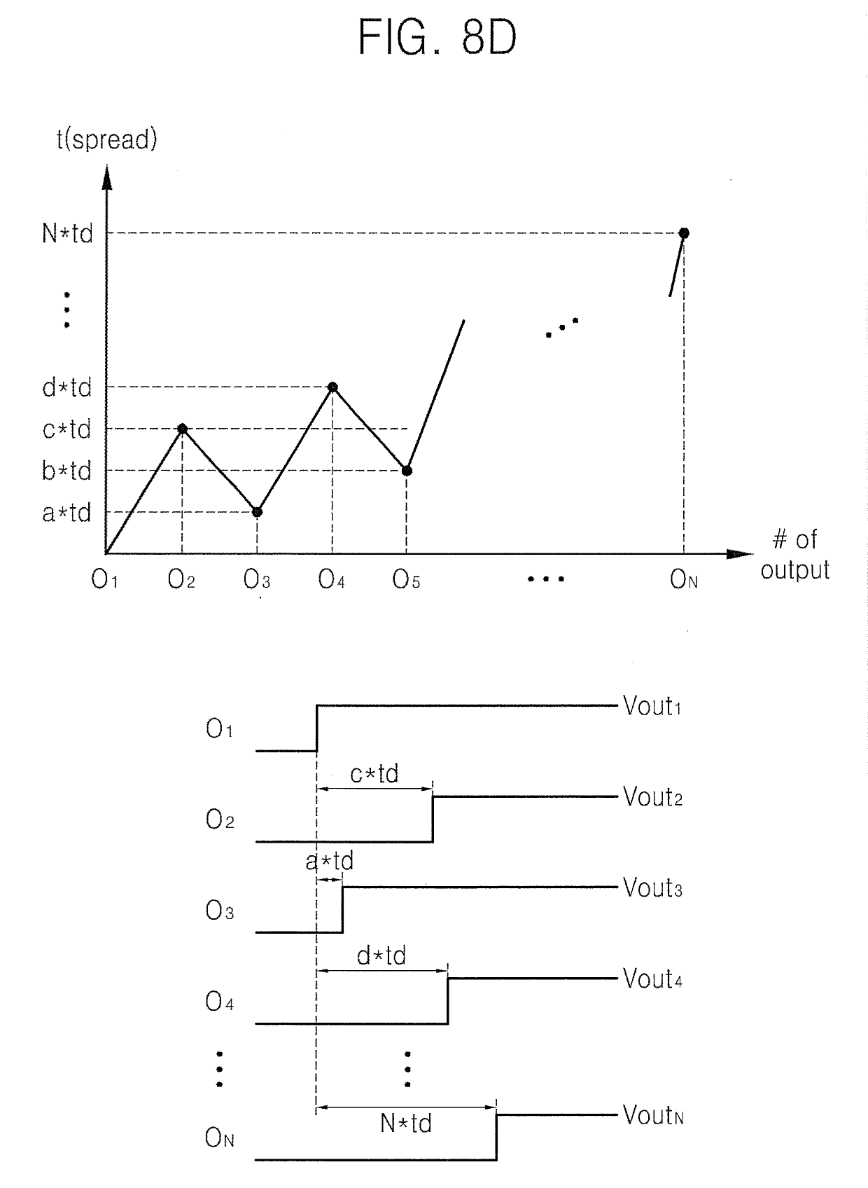

FIG. 8A is a diagram for explaining a zigzag spreading output driving scheme of the output driver 200 according to some embodiments of the inventive concepts.

Referring to FIG. 8A, the output driver 200 may sequentially output signals Vout₁ through Vout_{N} to the data lines O₁ through O_{N}, respectively. When the output signals Vout₁ through Vout_{N} are output to the data lines O₁ through O_{N}, a parasitic capacitance Cc coupled between adjacent data lines Oₖ through Oₖ₊₁ is generated. The parasitic capacitance Cc alleviates the voltage of an output signal due to a load effect, thereby decreasing the level of a peak current.

The parasitic capacitance Cc is generated during a spreading time in which there exists a potential between adjacent data lines (e.g., the output signals Vout₃ and Vout₄ to the respective data lines O₃ and O₄ are high and low, respectively). The peak current of the output driver 200 is reduced using the parasitic capacitance Cc. As a result, electromagnetic interference (EMI) is also reduced. In other words, when the spreading time during which the parasitic capacitance Cc is generated is increased from a period \hat{1} to a period \hat{2} within a desired, (or alternatively a predetermined) range, e.g., td(max), the peak current and EMI is reduced.

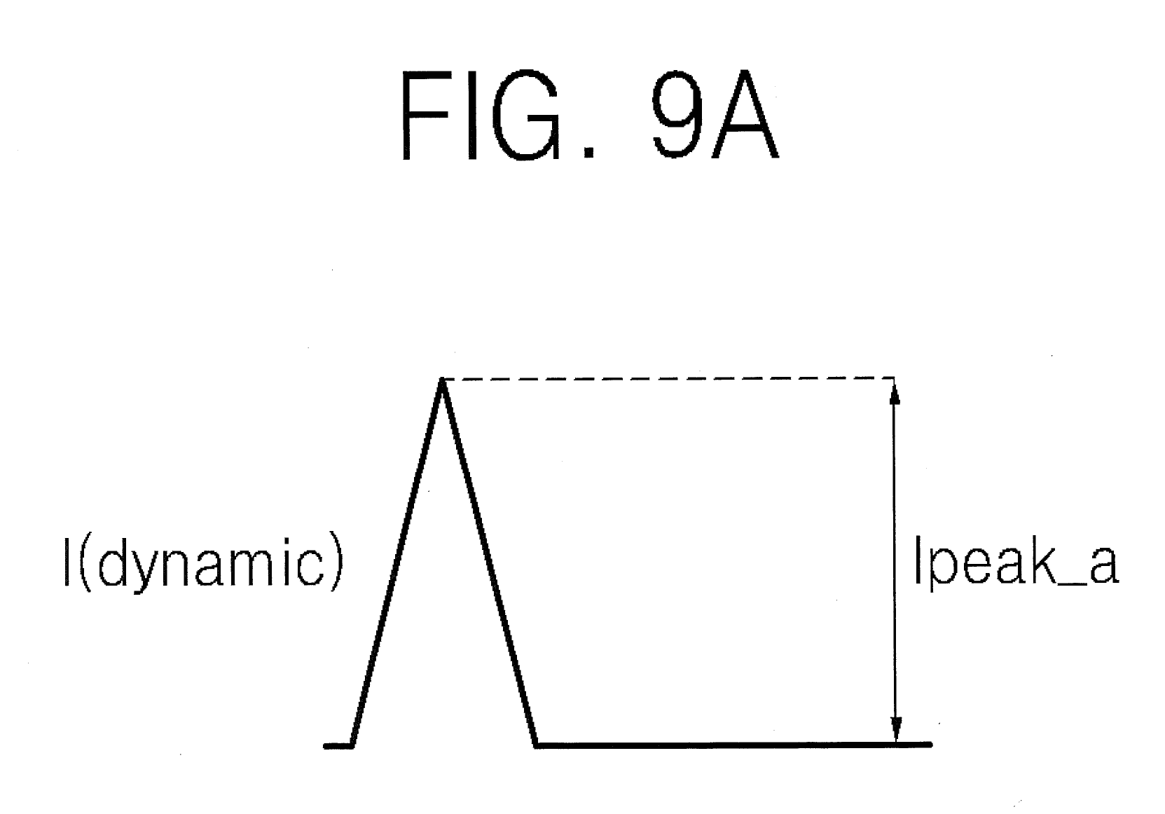

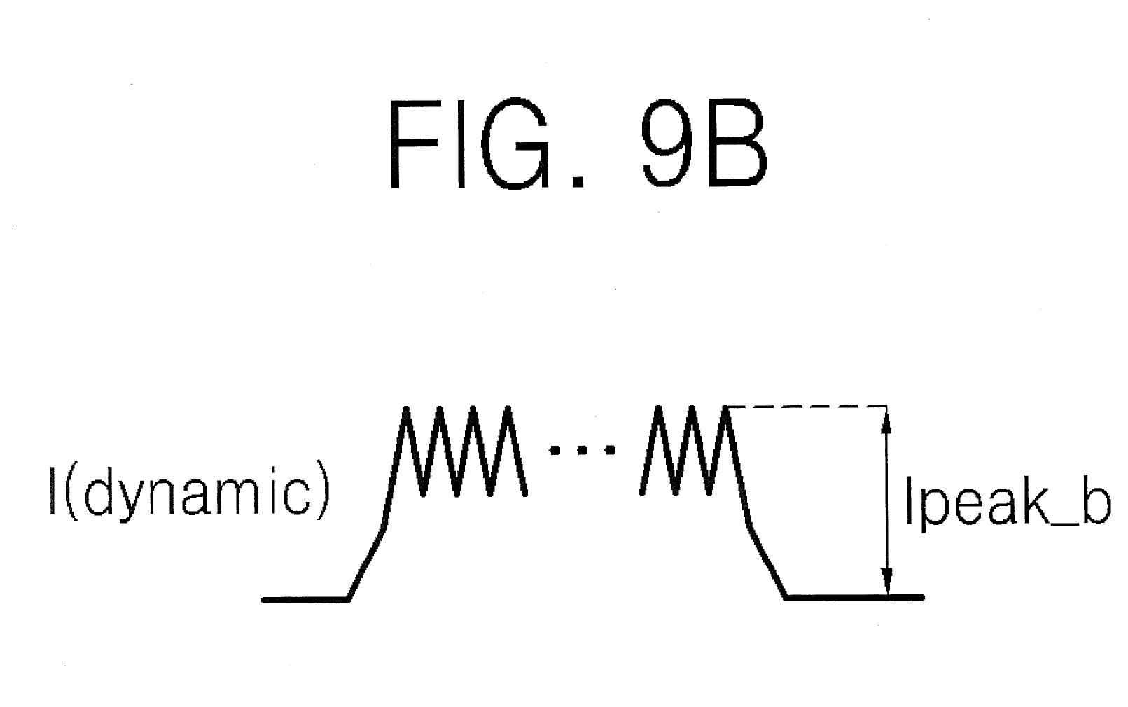

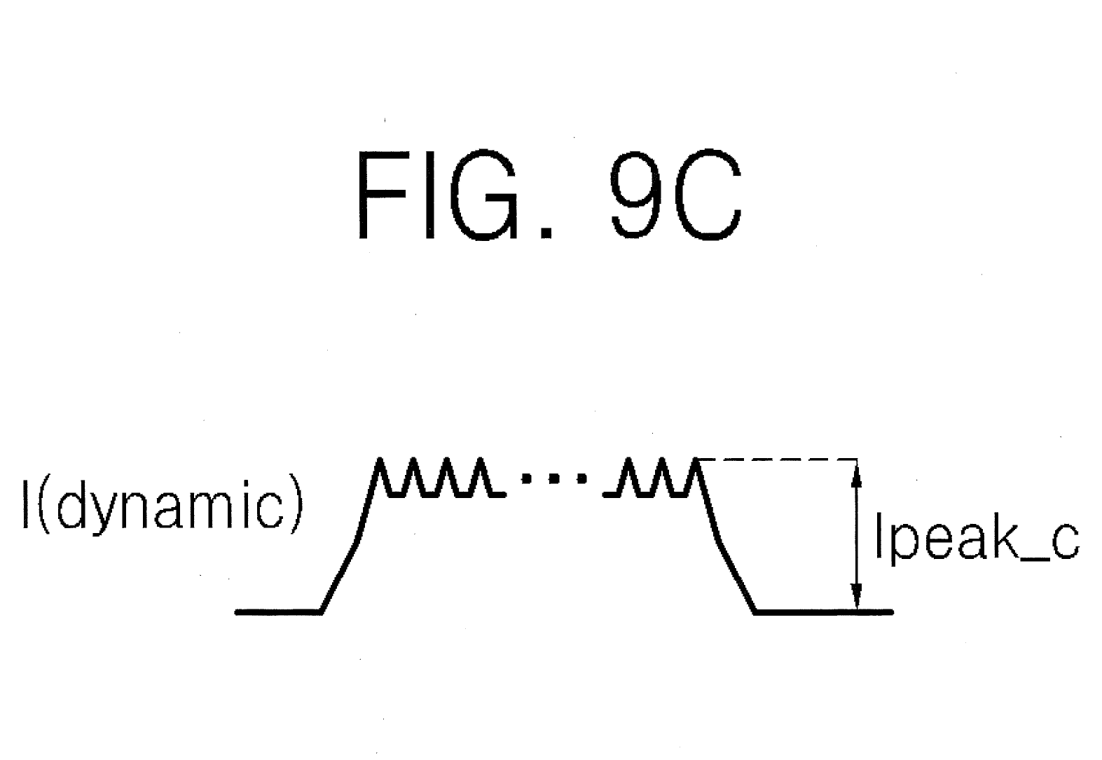

FIG. 8B shows output timings for data lines O₁ through O_{N} to explain a conventional simultaneous switching scheme. Referring to FIG. 8B, the output driver 200 outputs output signals Vout₁ through Vout_{N} to the data lines O₁ through O_{N} at the same time. Accordingly, a peak current Ipeak_a is high at an output point, as shown in FIG. 9A.

FIG. 8C shows output timings for data lines O₁ through O_{N} to explain a sequential spreading output driving scheme as a comparison example.

Referring to FIG. 8C, the output driver 200 outputs the output signals Vout₁ through Vout_{N} to the data lines O₁ through O_{N} so that output is spread. Here, the output signals Vout₁ through Vout_{N} are sequentially output. Accordingly, as illustrated in FIG. 9B, a peak current Ipeak_b occurring in the sequential switching scheme is lower than the peak current Ipeak_a (FIG. 9A) occurring in the simultaneous switching scheme. However, the sequential spreading output driving scheme illustrated in FIG. 8C allows a spreading time of only a unit interval “td” between adjacent channels, and therefore, there is a limit to reducing the level of a peak current.

FIG. 8D shows output timings for data lines O₁ through O_{N} to explain a zigzag spreading output driving scheme according to some embodiments of the inventive concepts.

As illustrated in FIG. 8D, when a spreading time is maximized by spreading outputs in a zigzag pattern, the slope of an output voltage is slowed due to the load effect of a parasitic capacitance, and therefore, the level of a peak current is further decreased. In detail, the spreading time between adjacent data lines, for example, c*td between O₁ and O₂, (c-a)*td between O₂ and O₃, and (d-a)*td between O₃ and O₄, in the zigzag spreading output driving scheme is longer than the spreading time between adjacent data lines in the sequential spreading output driving scheme, and therefore, the zigzag spreading output driving scheme further decrease a peak current and an EMI level as compared to the sequential spreading output driving scheme. Accordingly, as illustrated in FIG. 9C, a peak current Ipeak_c occurring in the zigzag spreading output driving scheme is lower than the peak current Ipeak_b (FIG. 9B) occurring in the sequential spreading output driving scheme.

However, since a maximum spreading time is limited with respect to all data lines, a spreading time between adjacent channels needs to be maximized in order to optimize the load effect of parasitic capacitance during the maximum spreading time. The slope of an output signal is slowed during such maximized spreading time and the level of a peak current is reduced as much as the slope is slowed.

Referring to FIGS. 3 and 8D, each delay cell 111 in the spreading delay-cell array 100 may include a plurality of buffers in order to adjust the output timing of an output signal. For instance, when it is assumed that it takes a time of the unit interval “td” for an output signal to pass through a single buffer, a delay cell 111 connected to the first data line O₁ may include no buffer, a delay cell 111 connected to the second data line O₂ may include “c” buffers, a delay cell 111 connected to the third data line O₃ may include “a” buffers, a delay cell 111 connected to the fourth data line O₄ may include “d” buffers, and a delay cell 111 connected to the fifth data line O₅ may include “b” buffers, where 0<a<b<c<d≦N. The spreading delay-cell array 100 may be implemented as described above, but the inventive concepts are not restricted thereto.

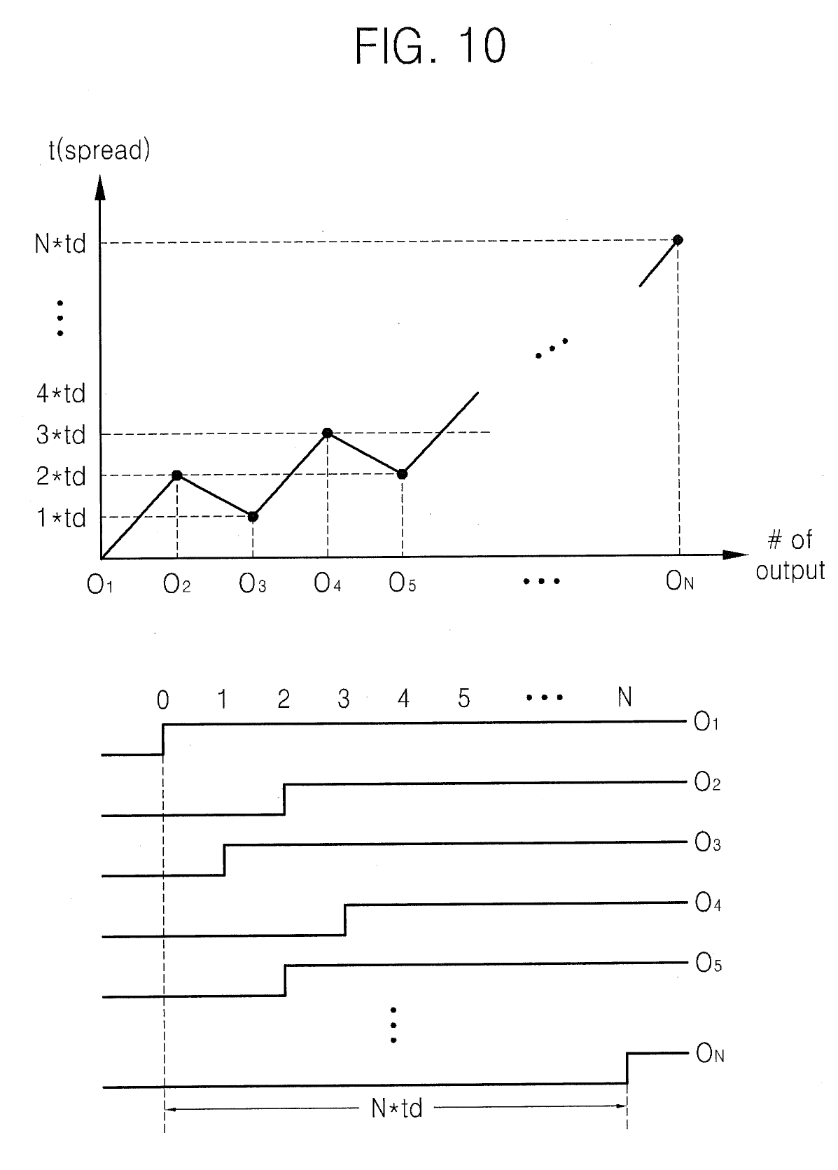

FIG. 10 illustrates an exemplary data line-time graph showing the output timings for data lines O₁ through O_{N} in a zigzag spreading output scheme according to some embodiments of the inventive concepts. The zigzag spreading output scheme illustrated in FIG. 10 may be performed by the output driver 200 or 200′ illustrated in FIGS. 2 through 7D. Referring to FIG. 10, spreading times between adjacent data lines (i.e., differences between output timings for adjacent data lines) have a zigzag pattern in which spreading times of (+2) td and (−1)td are alternately repeated.

For instance, the output timing for the first data line O₁ is 0*td, the output timing for the second data line O₂ is 2*td, the output timing for the third data line O₃ is 1*td, the output timing for the fourth data line O₄ is 3*td, and the output timing for the fifth data line O₅ is 2*td, so that outputs are spread in the zigzag pattern.

In other words, a spreading time between the first data line O₁ and the second data line O₂ is 2*td, a spreading time between the second data line O₂ and the third data line O₃ is 1*td, a spreading time between the third data line O₃ and the fourth data line O₄ is 2*td, and a spreading time between the fourth data line O₄ and the fifth data line O₅ is 1*td, so that output timing for an adjacent data line lags by 2*td and then leads by 1*td and this pattern is repeated.

As a result, parasitic capacitance is generated during the 2*td (from 0*td to 2*td) between the first data line O₁ and the second data line O₂ and during the 1*td (from 1*td to 2*td) between the second data line O₂ and the third data line O₃ and, in the same manner, during the 2*td (from 1*td to 3*td) between the third data line O₃ and the fourth data line O₄ and during the 1*td (from 2*td to 3*td) between the fourth data line O₄ and the fifth data line O₅, so that the slope of the voltages of output signals is decreased due to the load effect. Consequently, peak current is decreased.

However, since the maximum spreading time for all data lines is limited, the lagging and the leading of the output timing need to be designed such that a difference between the output timing for a data line (e.g., O₁ in FIG. 5) having the earliest output timing and the output timing for a data line (e.g., O_{N} in FIG. 5) having the latest output timing is within a desired, (or alternatively a predetermined) range.

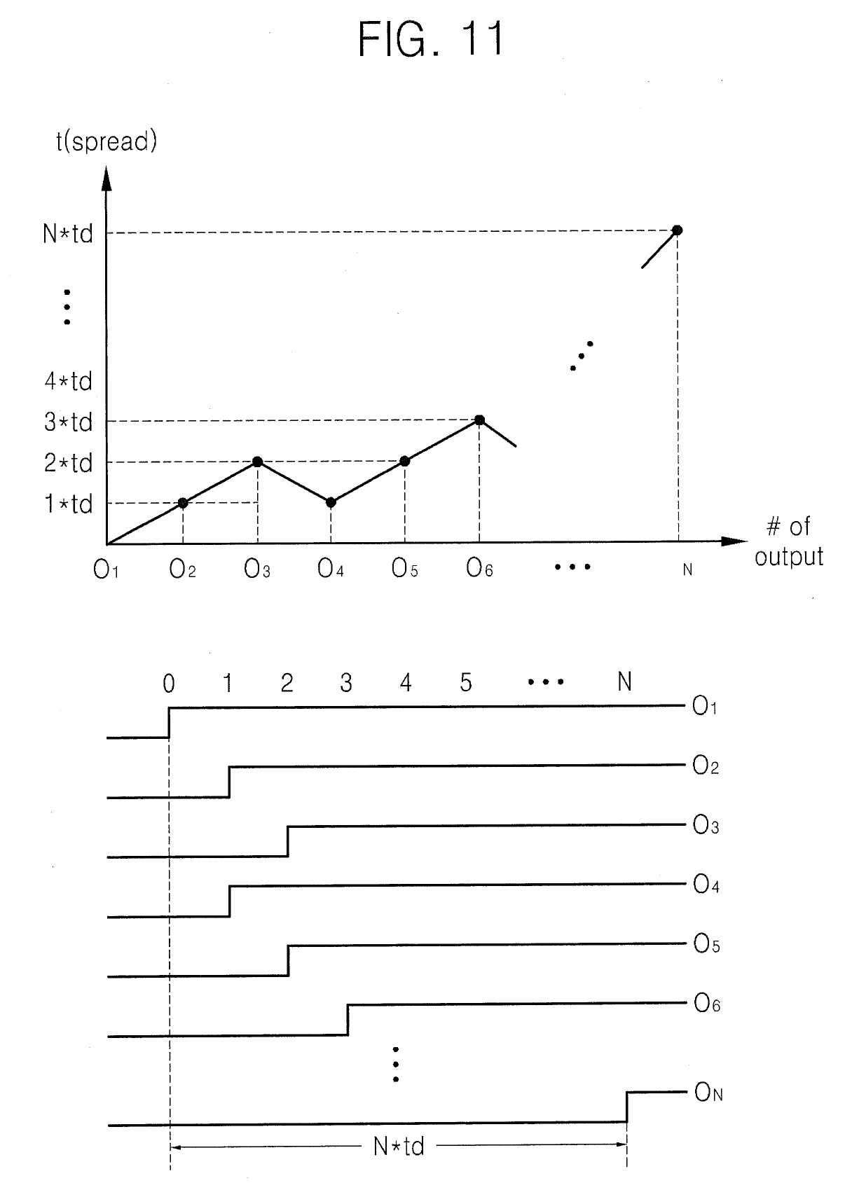

FIG. 11 is a data line-time graph showing the output timings for data lines O₁ through O_{N} in a zigzag spreading output scheme according to other embodiments of the inventive concepts. The zigzag spreading output method illustrated in FIG. 11 may be performed by the output driver 200 or 200′ illustrated in FIGS. 2 through 7D. Referring to FIG. 11, spreading times between adjacent data lines (i.e., differences between output timings for adjacent data lines) have a zigzag pattern in which a pattern of spreading times of (+1) td, (+1) td and (−1)td is repeated.

For instance, the output timing for the first data line O₁ is 0*td, the output timing for the second data line O₂ is 1*td, the output timing for the third data line O₃ is 2*td, the output timing for the fourth data line O₄ is 1*td, the output timing for the fifth data line O₅ is 2*td, and the output timing for the sixth data line O₆ is 3*td, so that outputs are spread in the zigzag pattern.

In other words, a spreading time between the first data line O₁ and the second data line O₂ is 1*td, a spreading time between the second data line O₂ and the third data line O₃ is 1*td, a spreading time between the third data line O₃ and the fourth data line O₄ is 1*td, and a spreading time between the fourth data line O₄ and the fifth data line O₅ is 1*td, so that output timing for an adjacent data line lags by 1*td, then lags by 1*td again and then leads by 1*td and this pattern is repeated.

As a result, parasitic capacitance is generated during the 1*td (from 0*td to 1*td) between the first data line O₁ and the second data line O₂ and during the 1*td (from 1*td to 2*td) between the second data line O₂ and the third data line O₃ and, in the same manner, during the 1*td (from 1*td to 2*td) between the third data line O₃ and the fourth data line O₄ and during the 1*td (from 2*td to 3*td) between the fourth data line O₄ and the fifth data line O₅, so that the slope of the voltages of output signals is decreased due to the load effect. Consequently, peak current is decreased.

However, since the maximum spreading time for all data lines is limited, the lagging and the leading of the output timing need to be designed such that a difference between the output timing for a data line (e.g., O₁ in FIG. 6) having the earliest output timing and the output timing for a data line (e.g., O_{N} in FIG. 6) having the latest output timing is within a desired, (or alternatively a predetermined) range.

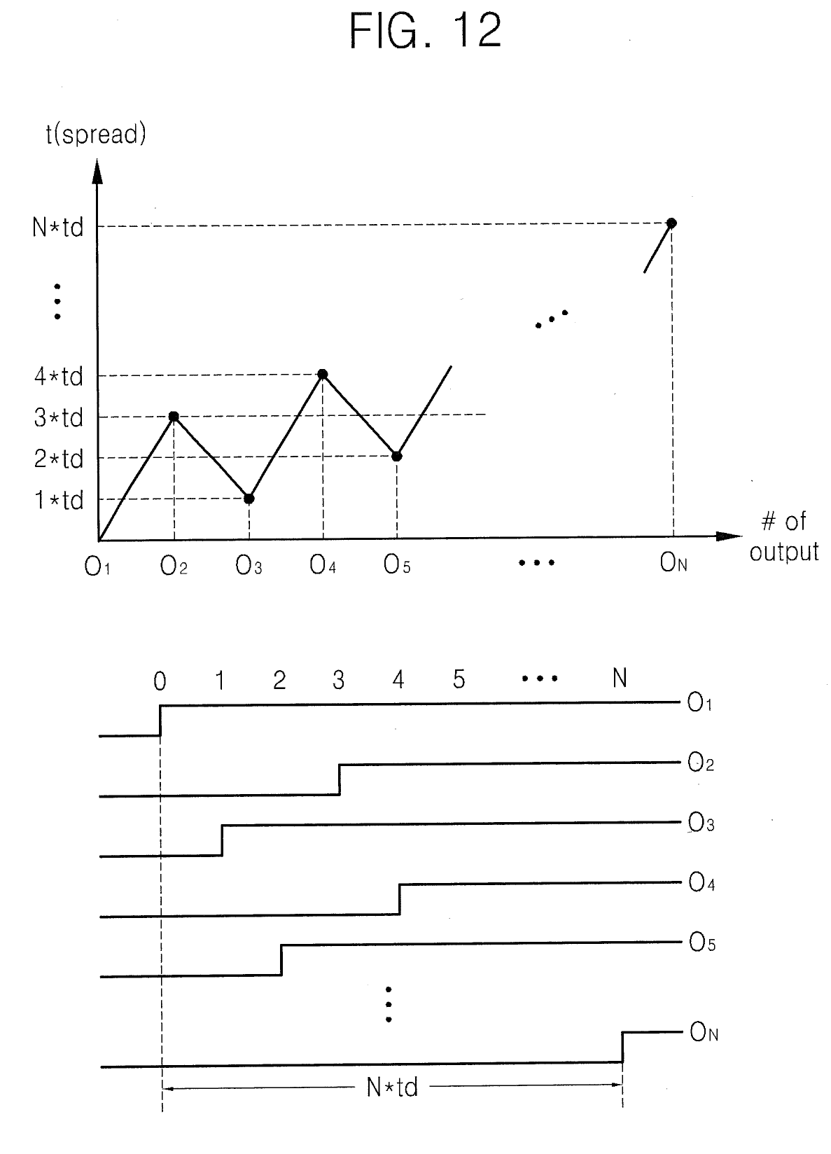

FIG. 12 is a data line-time graph showing the output timings for data lines O₁ through O_{N} in a zigzag spreading output scheme according to further embodiments of the inventive concepts. The zigzag spreading output method illustrated in FIG. 12 may be performed by the output driver 200 or 200′ illustrated in FIGS. 2 through 7D. Referring to FIG. 12, spreading times between adjacent data lines (i.e., differences between output timings for adjacent data lines) have a zigzag pattern in which spreading times of (+3) td and (−2)td are alternately repeated.

For instance, the output timing for the first data line O₁ is 0*td, the output timing for the second data line O₂ is 3*td, the output timing for the third data line O₃ is 1*td, the output timing for the fourth data line O₄ is 4*td, and the output timing for the fifth data line O₅ is 2*td, so that outputs are spread in the zigzag pattern.

In other words, a spreading time between the first data line O₁ and the second data line O₂ is 3*td, a spreading time between the second data line O₂ and the third data line O₃ is 2*td, a spreading time between the third data line O₃ and the fourth data line O₄ is 3*td, and a spreading time between the fourth data line O₄ and the fifth data line Oₛ is 2*td, so that output timing for an adjacent data line lags by 3*td and then leads by 2*td and this pattern is repeated.

As a result, parasitic capacitance is generated during the 3*td (from 0*td to 3*td) between the first data line O₁ and the second data line O₂ and during the 2*td (from 1*td to 3*td) between the second data line O₂ and the third data line O₃ and, in the same manner, during the 3*td (from 1*td to 4*td) between the third data line O₃ and the fourth data line O₄ and during the 2*td (from 2*td to 4*td) between the fourth data line O₄ and the fifth data line O₅, so that the slope of the voltages of output signals is decreased due to the load effect. Consequently, peak current is decreased.

However, since the maximum spreading time for all data lines is limited, the lagging and the leading of the output timing need to be designed such that a difference between the output timing for a data line (e.g., O₁ in FIG. 12 having the earliest output timing and the output timing for a data line (e.g., O_{N} in FIG. 12 having the latest output timing is within a desired, (or alternatively a predetermined) range.

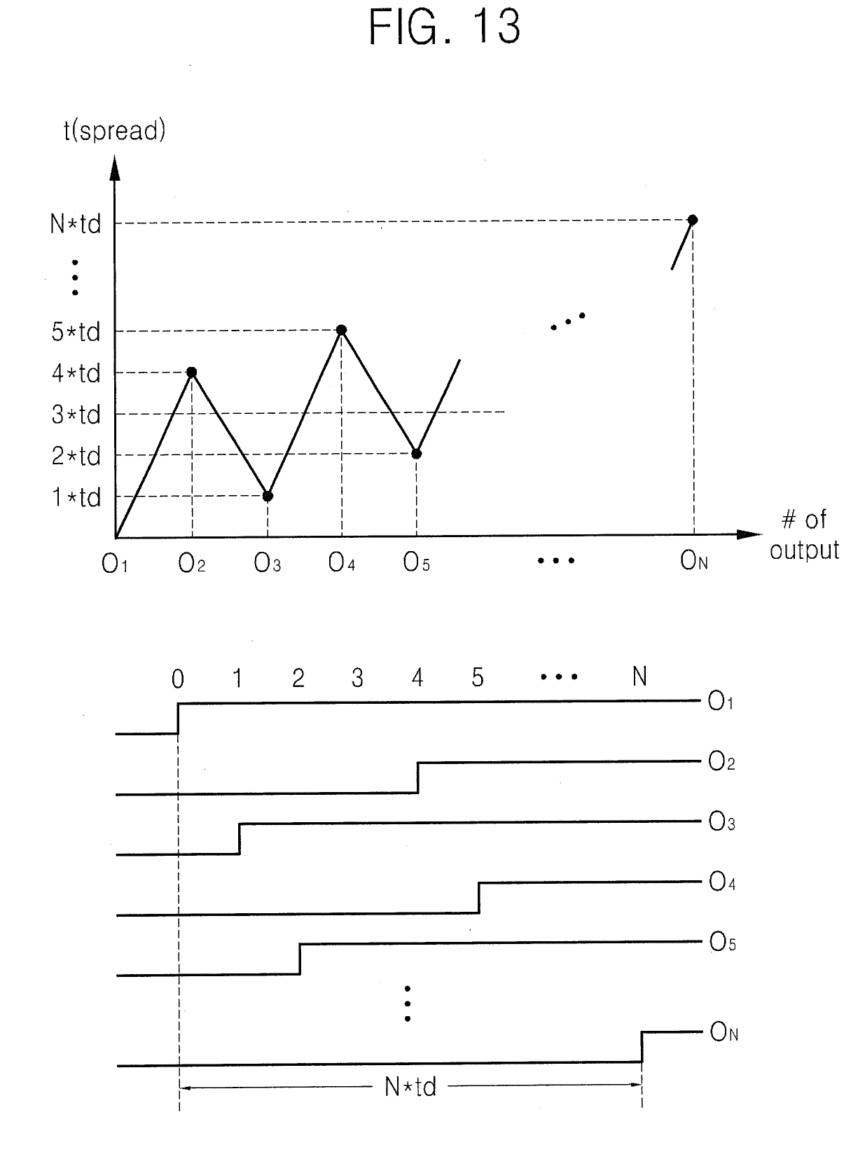

FIG. 13 is a data line-time graph showing the output timings for data lines O₁ through O_{N} in a zigzag spreading output scheme according to other embodiments of the inventive concept. The zigzag spreading output method illustrated in FIG. 13 may be performed by the output driver 200 or 200′ illustrated in FIGS. 2 through 7D. Referring to FIG. 13, spreading times between adjacent data lines (i.e., differences between output timings for adjacent data lines) have a zigzag pattern in which spreading times of (+4) td and (−3) td are alternately repeated.

For instance, the output timing for the first data line O₁ is 0*td, the output timing for the second data line O₂ is 4*td, the output timing for the third data line O₃ is 1*td, the output timing for the fourth data line O₄ is 5*td, and the output timing for the fifth data line O₅ is 2*td, so that outputs are spread in the zigzag pattern.

In other words, a spreading time between the first data line O₁ and the second data line O₂ is 4*td, a spreading time between the second data line O₂ and the third data line O₃ is 3*td, a spreading time between the third data line O₃ and the fourth data line O₄ is 4*td, and a spreading time between the fourth data line O₄ and the fifth data line O₅ is 3*td, so that output timing for an adjacent data line lags by 4*td and then leads by 3*td and this pattern is repeated.

As a result, parasitic capacitance is generated during the 4*td (from 0*td to 4*td) between the first data line O₁ and the second data line O₂ and during the 3*td (from 1*td to 4*td) between the second data line O₂ and the third data line O₃ and, in the same manner, during the 4*td (from 1*td to 5*td) between the third data line O₃ and the fourth data line O₄ and during the 3*td (from 2*td to 5*td) between the fourth data line O₄ and the fifth data line O₅, so that the slope of the voltages of output signals is decreased due to the load effect. Consequently, peak current is decreased.

However, since the maximum spreading time for all data lines is limited, the lagging and the leading of the output timing need to be designed such that a difference between the output timing for a data line (e.g., O₁ in FIG. 13) having the earliest output timing and the output timing for a data line (e.g., O_{N} in FIG. 13) having the latest output timing is within a desired, (or alternatively a predetermined) range.

The inventive concepts are not restricted to the output timings in the embodiments illustrated in FIGS. 10 through 13 and may be embodied in various ways according to the physical or environmental characteristics of a display panel. For instance, output timings for a plurality of data lines may be adjusted to be in a zigzag pattern in such a way that an output timing for a (k+1)-th data line adjacent to a k-th data line may lag behind an output timing for the k-th data line by L (which is a positive real number) times of the unit interval “td” and an output timing for a (k+2)-th data line adjacent to the (k+1)-th data line may lead the output timing for the (k+1)-th data line by M (which is a positive real number) times of the unit interval “td”.

At this time, an output signal of an output driver may be a digital or an analog signal corresponding to data. The digital or analog signal may be a signal having one of a plurality of levels (e.g., 256 levels) into which a desired, (or alternatively a predetermined) range of voltage or time is divided.

In some embodiments according to the inventive concepts, a zigzag spreading scheme may be changed depending on a mode. For instance, the zigzag spreading scheme illustrated in FIG. 10 may be used in a first mode, the zigzag spreading scheme illustrated in FIG. 11 may be used in a second mode, and the zigzag spreading scheme illustrated in FIG. 12 may be used in a third mode. The zigzag spreading scheme is changed according to the mode in order to choose the best scheme optimal to the type or the resolution of a display panel.

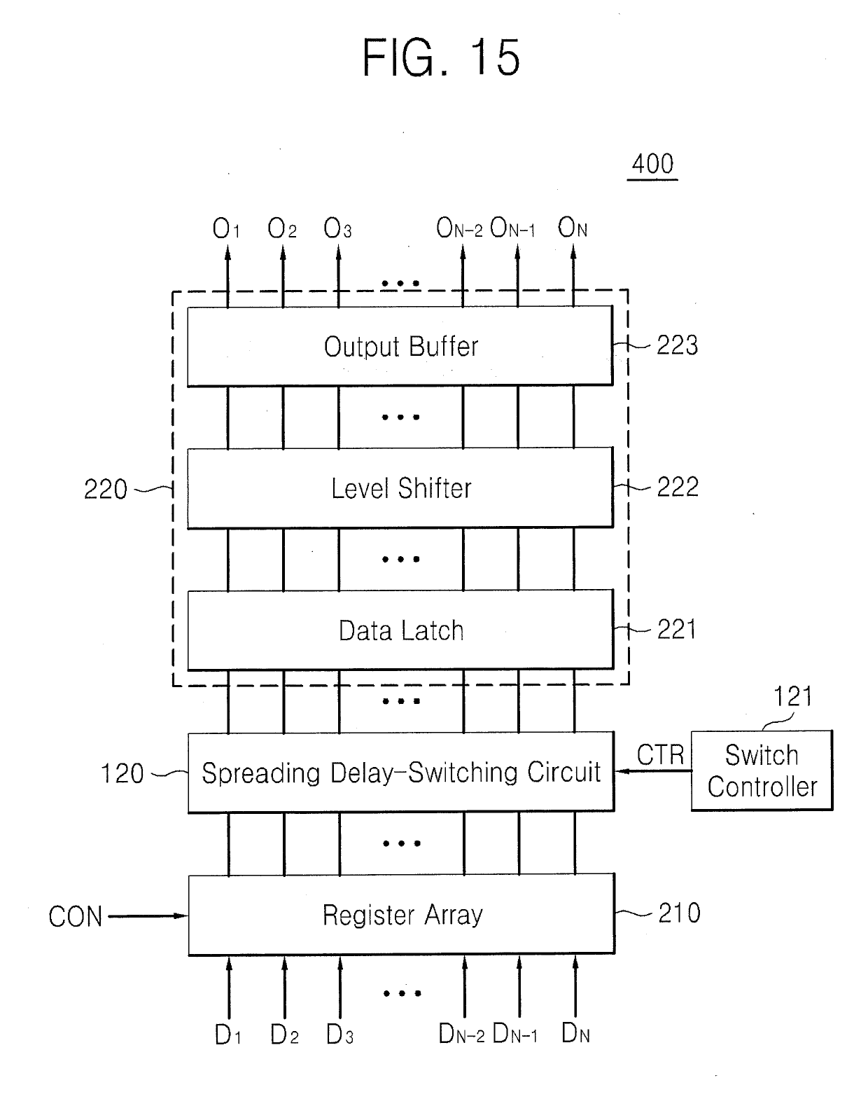

Although a function of selecting a mode is not shown, the function may be performed by the control circuit 25. When the control circuit 25 selects a mode among a plurality of modes, the control circuit 25 may provide the delay control signal DCTR corresponding to the selected mode to the delay controller 112 or provide a control signal CTR to a switch controller 121 (FIG. 15).

As described above, a zigzag spreading output scheme according to some embodiments of the inventive concepts is not a control making the output timings of signals sequentially increase or decrease (that is, the output timings sequentially lag behind or lead one after another) but is a control to make a pattern of increasing (lagging) and then decreasing (leading) or a pattern decreasing (leading) and then increasing (lagging) in output timings occur at least one time.

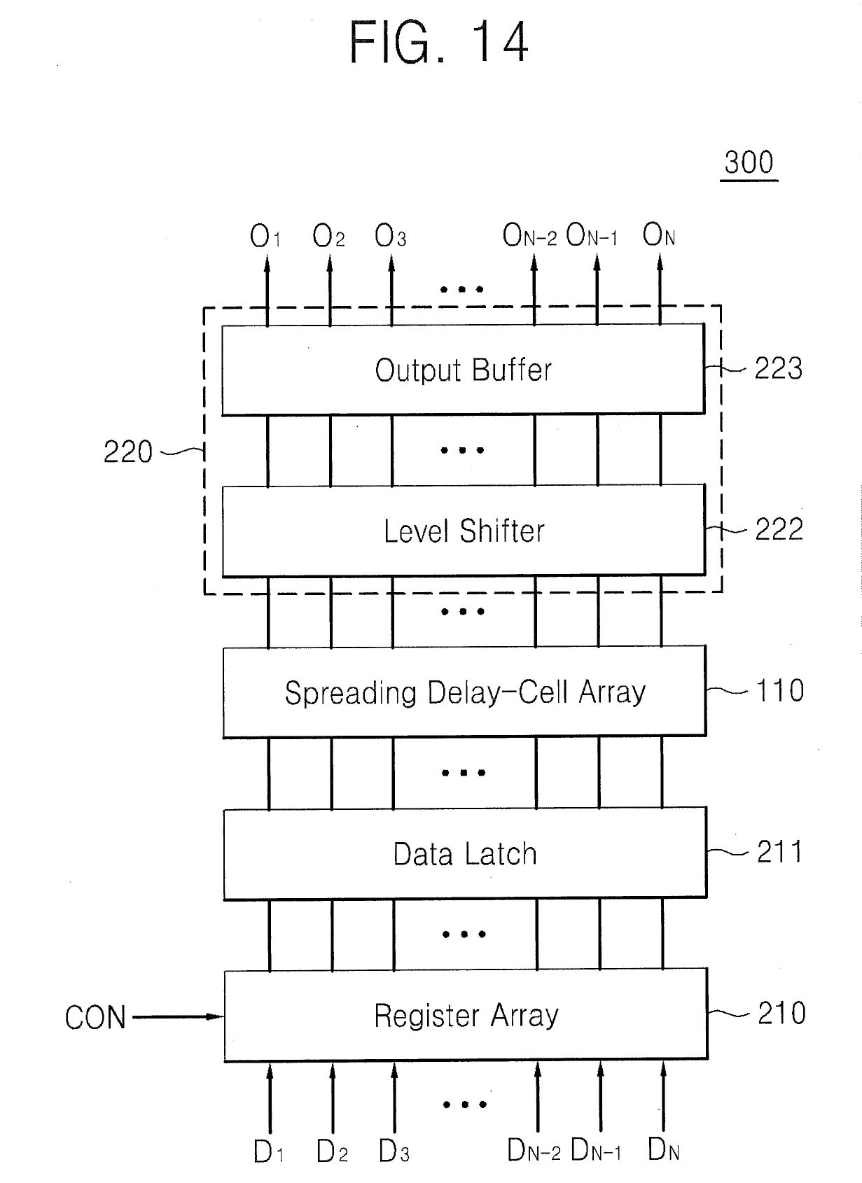

FIG. 14 is a block diagram of an output driver 300 according to other embodiments of the inventive concepts.

Referring to FIG. 14, the output driver (i.e., a source driver, a W-driver or a data driver) 300 may include the register array 210, a latch circuit 211, a spreading delay-cell array 110, and the output module 220. For the sake of convenience in the description, differences between the output driver 300 and the output driver 200 illustrated in FIG. 2 will be described.

Unlike the spreading delay-cell array 100 illustrated in FIG. 2, the spreading delay-cell array 110 is connected with output lines of the latch circuit 211 to adjust output timings in a zigzag pattern. The latch circuit 211 latches data. Accordingly, after the data is latched in response to a clock signal or a special signal, the output timings of the data are adjusted in the zigzag pattern just before the data is finally output, that is, just before the output module 220.

At this time, the output module 220 outputs the data to data lines according to the adjusted output timings. The output module 220 may include the level shifter 222 and the output buffer 223. The level shifter 222 shifts the levels of output signals O₁ through O_{N} of which the output timings have been adjusted. The output buffer 223 outputs the shifted output signals O₁ through O_{N} to the respective data lines.

FIG. 15 is a block diagram of an output driver 400 according to further embodiments of the inventive concepts.

Referring to FIG. 15, the output driver (i.e., a source driver, a W-driver or a data driver) 400 may include the register array 210, a spreading delay-switching circuit 120, a switch controller 121, and the output module 220. For the sake of convenience in the description, differences between the output driver 400 and the output driver 200 illustrated in FIG. 2 will be described.

The spreading delay-switching circuit 120 is connected with output lines of the register array 210 to adjust output timings in a zigzag pattern. Unlike the spreading delay-cell array 100 illustrated in FIG. 2, the spreading delay-switching circuit 120 may include a plurality of (e.g., N, i.e., the number of data lines) switching elements.

The switch controller 121 generates the control signal CTR for turning on or off the switching elements in the spreading delay-switching circuit 120. At this time, the control signal CTR includes at least one bit and the switch controller 121 may be connected with each of the switching elements, but the inventive concepts are not restricted to the current embodiments.

The spreading delay-switching circuit 120 turns on each of the switching elements respectively connected with data lines at a corresponding output timing in response to the control signal CTR, thereby adjusting output timings for the respective data lines in the zigzag pattern.

The output module 220 outputs data to the data lines according to the adjusted output timings. The output module 220 may include the latch circuit 221, the level shifter 222 and the output buffer 223.

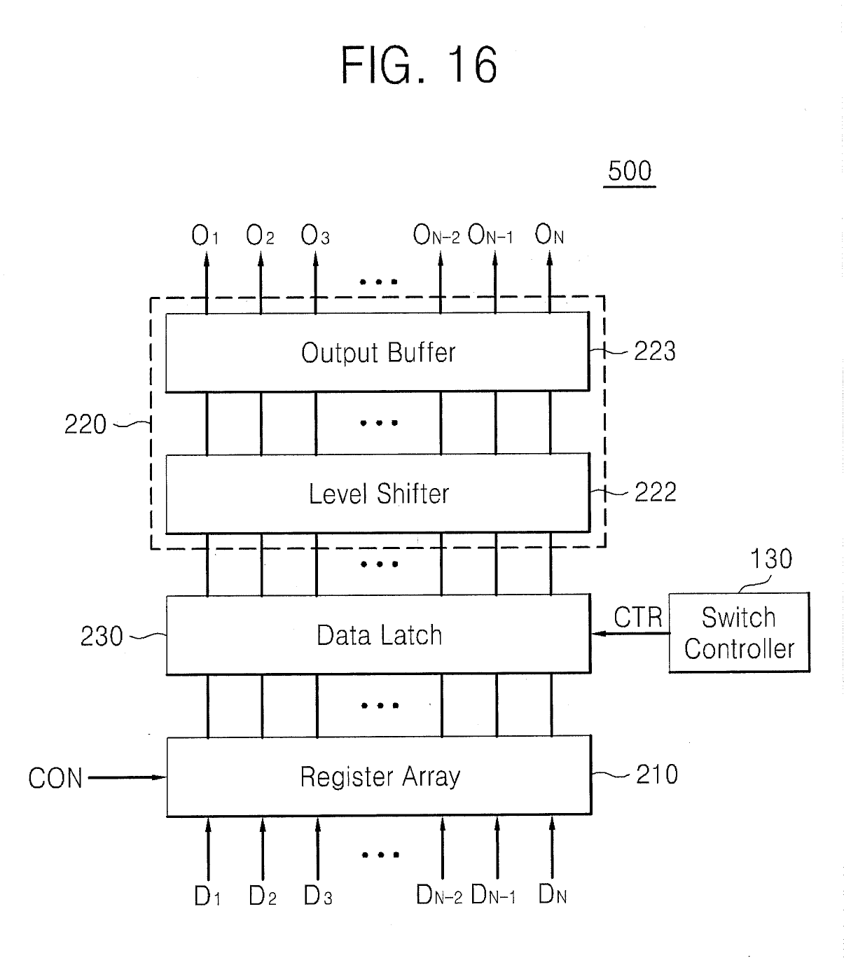

FIG. 16 is a block diagram of an output driver 500 according to other embodiments of the inventive concepts.

Referring to FIG. 16, the output driver (i.e., a source driver, a W-driver or a data driver) 500 includes the register array 210, a latch circuit 230, a switch controller 130, and the output module 220. For the sake of convenience in the description, differences between the output driver 500 and the output driver 200 illustrated in FIG. 2 will be described.

The latch circuit 230 latches data in response to a control signal CTR apart from a clock signal, thereby adjusting the output timings of the data in a zigzag pattern.

The switch controller 130 generates the control signal CTR for controlling the output of data to data lines in the latch circuit 230. At this time, the control signal CTR includes at least one bit and may be applied to each of the data lines in the latch circuit 230, but the inventive concepts are not restricted to the current embodiments.

The latch circuit 230 latches and outputs data for each data line in response to the control signal CTR, thereby adjusting output timings of the data for the respective data lines in the zigzag pattern.

The output module 220 outputs the data to the data lines according to the adjusted output timings. The output module 220 may include the level shifter 222 and the output buffer 223.

FIGS. 2, 5, 14 through 16, 8D and 10 through 13 show examples of an output driver for realizing zigzag spreading output driving schemes according to different embodiments of the inventive concepts. The inventive concepts are not restricted to those embodiments. For instance, the spreading delay-cell array 100 or the spreading delay-switching circuit 120 may be provided at a different position than the position shown in FIG. 2, 5, 14, 15, or 16. In other embodiments, the spreading delay-cell array 100 or the spreading delay-switching circuit 120 may not be provided, but the output buffer 223 or the latch circuit 221 may be configured to have a zigzag spreading output function.

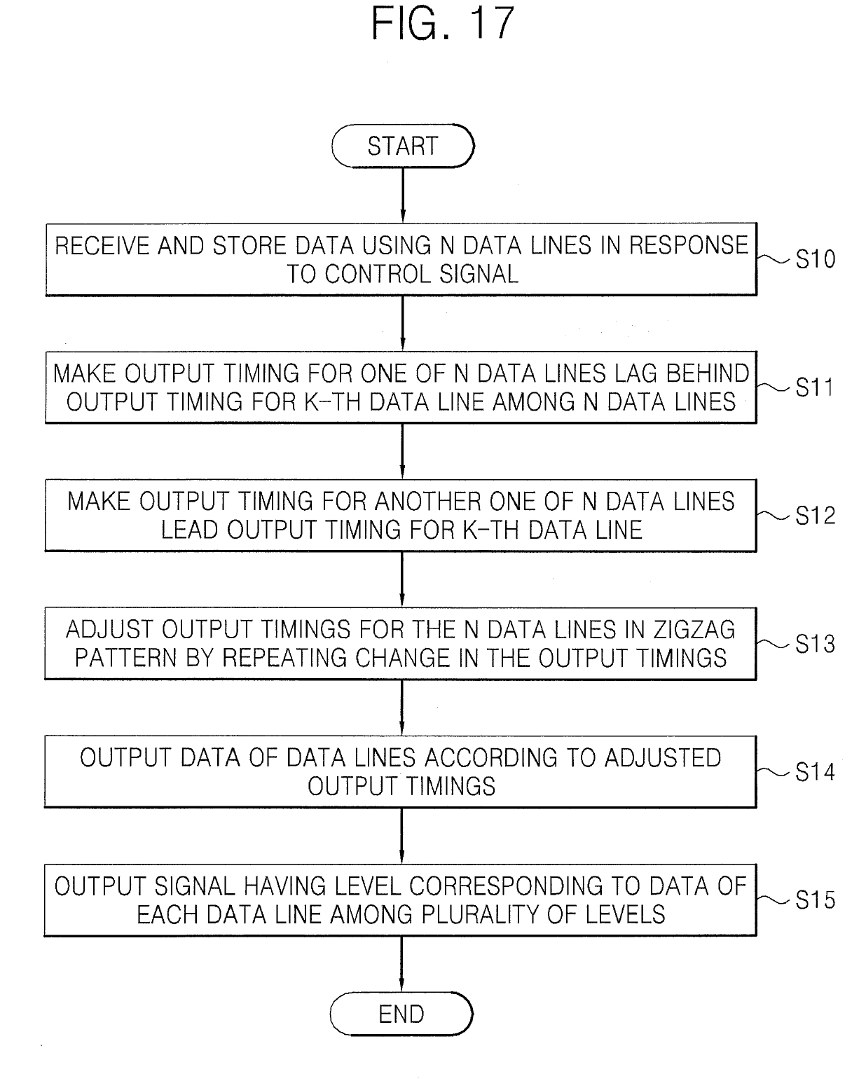

FIG. 17 is a flowchart of a method of driving a display device according to some embodiments of the inventive concepts.

Referring to FIG. 17, when data is input to an output driver 200, 200′ 300, 400, or 500, the output driver 200, 200′ 300, 400, or 500 receives and stores the data using a plurality of (e.g., N) data lines in response to a control signal CON in operation S10. The output driver 200, 200′ 300, 400, or 500 makes an output timing for one of the N data lines lag behind an output timing for a k-th data line among the N data lines in operation S11 and makes an output timing for another one of the N data lines lead the output timing for the k-th data line in operation S12, thereby reducing the slope of output voltages of adjacent data lines. The output driver 200, 200′ 300, 400, or 500 adjusts output timings for the N data lines in a zigzag pattern by repeating the change in the output timings in operation S13 and outputs the data of the N data lines at the adjusted output timings in operation S14. The output driver 200, 200′ 300, 400, or 500 outputs an analog or a digital signal having a level corresponding to the data of each data line among a plurality of levels in operation S15.

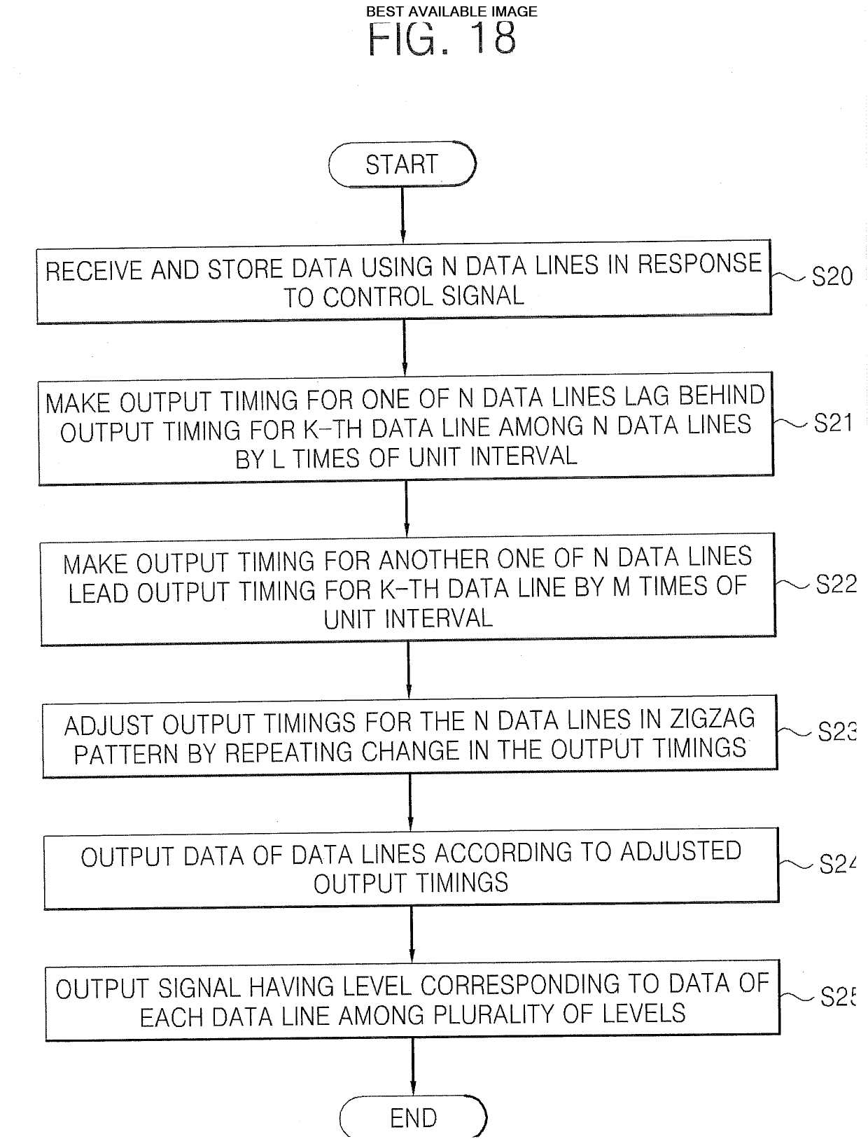

FIG. 18 is a flowchart of a method of driving a display device according to other embodiments of the inventive concepts.

Referring to FIG. 18, when data is input to the output driver 200, 200′ 300, 400, or 500, the output driver 200, 200′ 300, 400, or 500 receives and stores the data using a plurality of (e.g., N) data lines in response to a control signal CON in operation S20. The output driver 200, 200′ 300, 400, or 500 makes an output timing for one of the N data lines lag behind an output timing for a k-th data line among the N data lines by L times of a unit interval in operation S21 and makes an output timing for another one of the N data lines lead the output timing for the k-th data line by M times of the unit interval in operation S22, thereby reducing the slope of output voltages of adjacent data lines. At this time, when L or M increases, the slope decreases and the level of a peak current also decreases due to the load effect of parasitic capacitance. However, a difference between the earliest output timing and the latest output timing for the N data lines needs to be within a desired, (or alternatively a predetermined) range and may be changed according to the physical and/or environmental characteristics of the display device.

The output driver 200, 200′ 300, 400, or 500 adjusts output timings for the N data lines in a zigzag pattern by repeating the change in the output timings in operation S23 and outputs the data of the N data lines at the adjusted output timings in operation S24. The output driver 200, 200′ 300, 400, or 500 outputs an analog or a digital signal having a level corresponding to the data of each data line among a plurality of levels in operation S25.

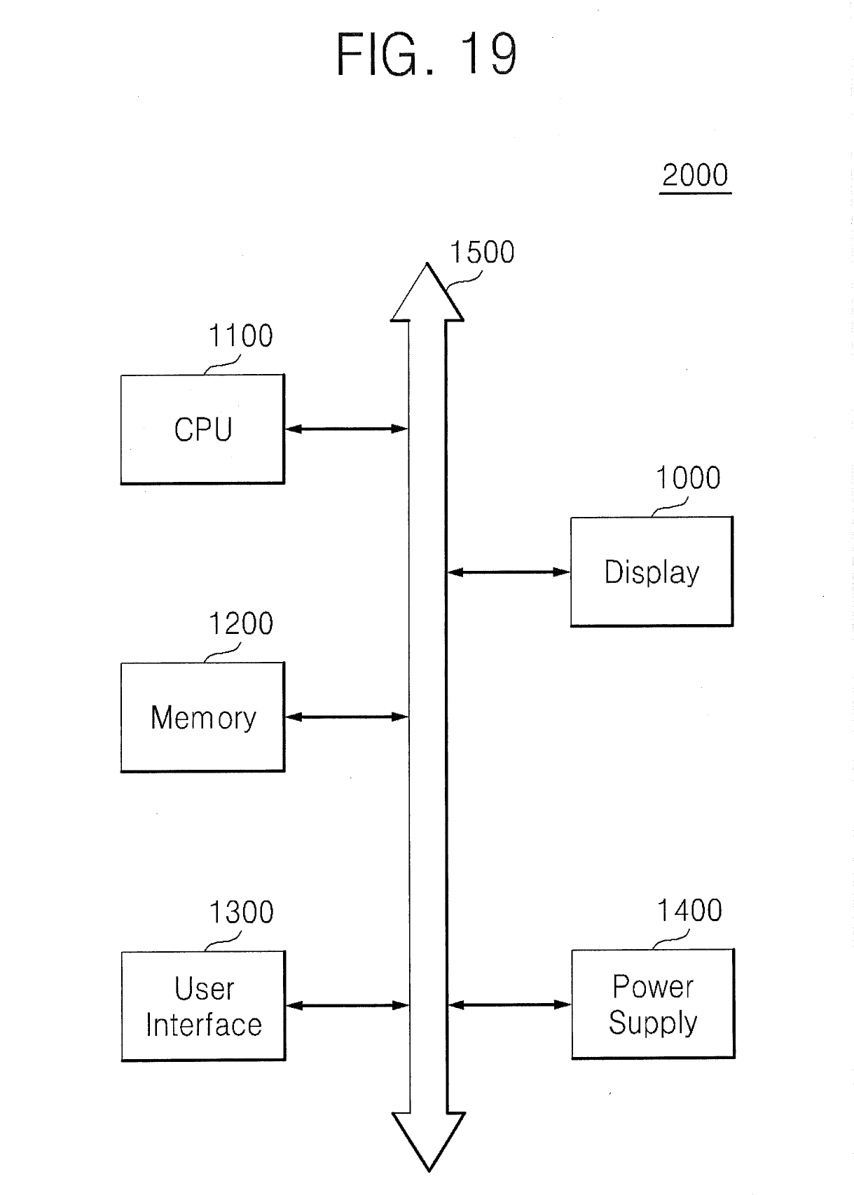

FIG. 19 is a block diagram of an electronic system 2000 including the display device 10 according to some embodiments of the inventive concept. The electronic system 2000 may be a mobile phone, a smart phone, a personal digital assistant (PDA), a camcorder, a car navigation system (CNS), or a portable multimedia player (PMP), but it is not restricted thereto.

Referring to FIG. 19, the electronic system 2000 may include the display device 1000, a power supply 1400, a central processing unit (CPU) 1100, a memory 1200, a user interface 1300, and a system bus 1500 electrically connecting the elements 10, 1400, 1100, 1200, and 1300 with one another. The display device 1000 may be the display device 10 or 20 described in the above-described embodiments of the inventive concept.

The CPU 1100 controls the overall operation of the electronic system 2000. The memory 1200 stores information necessary for the operation of the electronic system 2000. The user interface 1300 provides interface between the electronic system 2000 and a user. The power supply 1400 supplies electric power to other elements, i.e., the CPU 1100, the memory 1200, the user interface 1300, and the display device 1000.

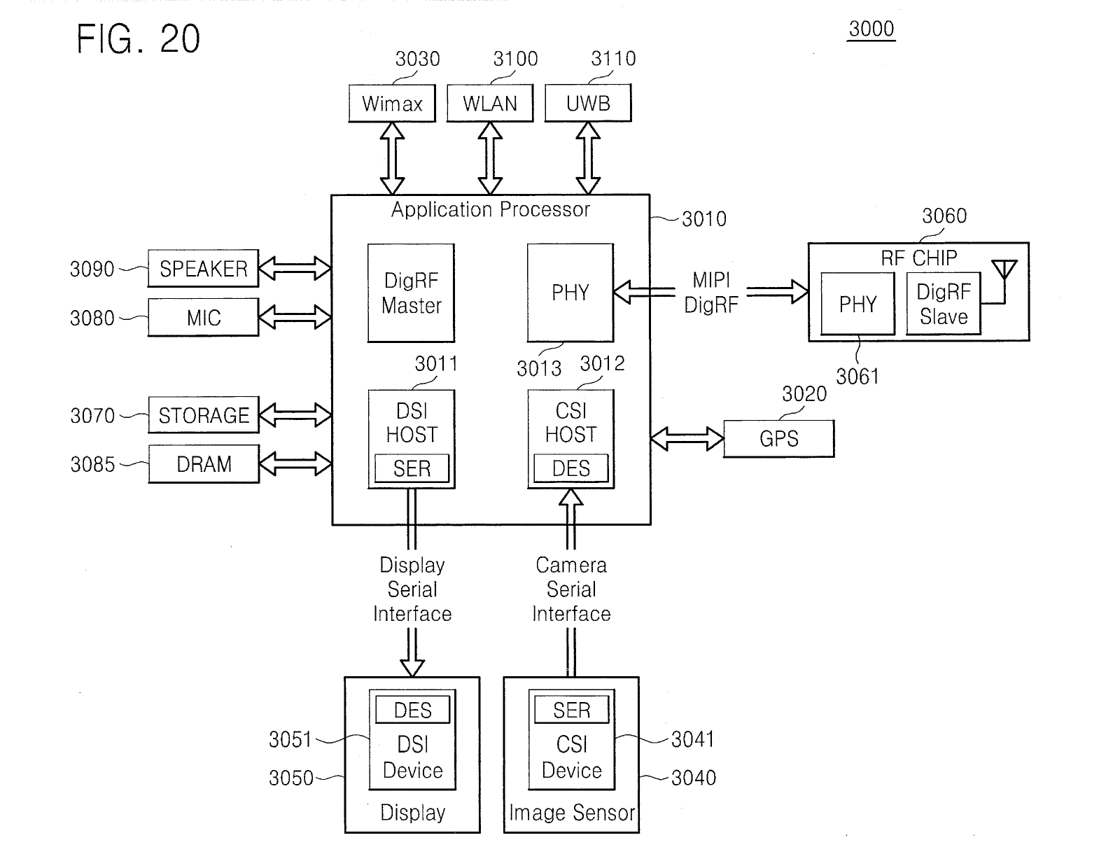

FIG. 20 is a block diagram of an electronic system 3000 including the display device 10 according to other embodiments of the inventive concept. Referring to FIG. 20, the electronic system 3000 may be implemented as a data processing device, such as a mobile phone, a PDA, a PMP, or a smart phone, which can use or support mobile industry processor interface (MIPI).

The electronic system 3000 includes an application processor 3010, an image sensor 3040, and a display 3050. The display 3050 may be the display device 10 or 20 described in the above-described embodiments of the inventive concept.

A camera serial interface (CSI) host 3012 implemented in the application processor 3010 may perform serial communication with a CSI device 3041 included in the image sensor 3040 through CSI. At this time, an optical deserializer and an optical serializer may be implemented in the CSI host 3012 and the CSI device 3041, respectively. A display serial interface (DSI) host 3011 implemented in the application processor 3010 may perform serial communication with a DSI device 3051 included in the display 3050 through DSI. At this time, an optical serializer and an optical deserializer may be implemented in the DSI host 3011 and the DSI device 3051, respectively.

The electronic system 3000 may also include a radio frequency (RF) chip 3060 communicating with the application processor 3010. A physical layer (PHY) 3013 of the application processor 3010 and a PHY 3061 of the RF chip 3060 may communicate data with each other according to MIPI DigRF.

The electronic system 3000 may further include a global positioning system (GPS) 3020, a storage 3070, a microphone (MIC) 3080, a dynamic random access memory (DRAM) 3085, and a speaker 3090. The electronic system 3000 may communicate using a Worldwide interoperability for microwave access (Wimax) 3030, a wireless local area network (WLAN) 3100, and an ultra-wideband (UWB) 3110.

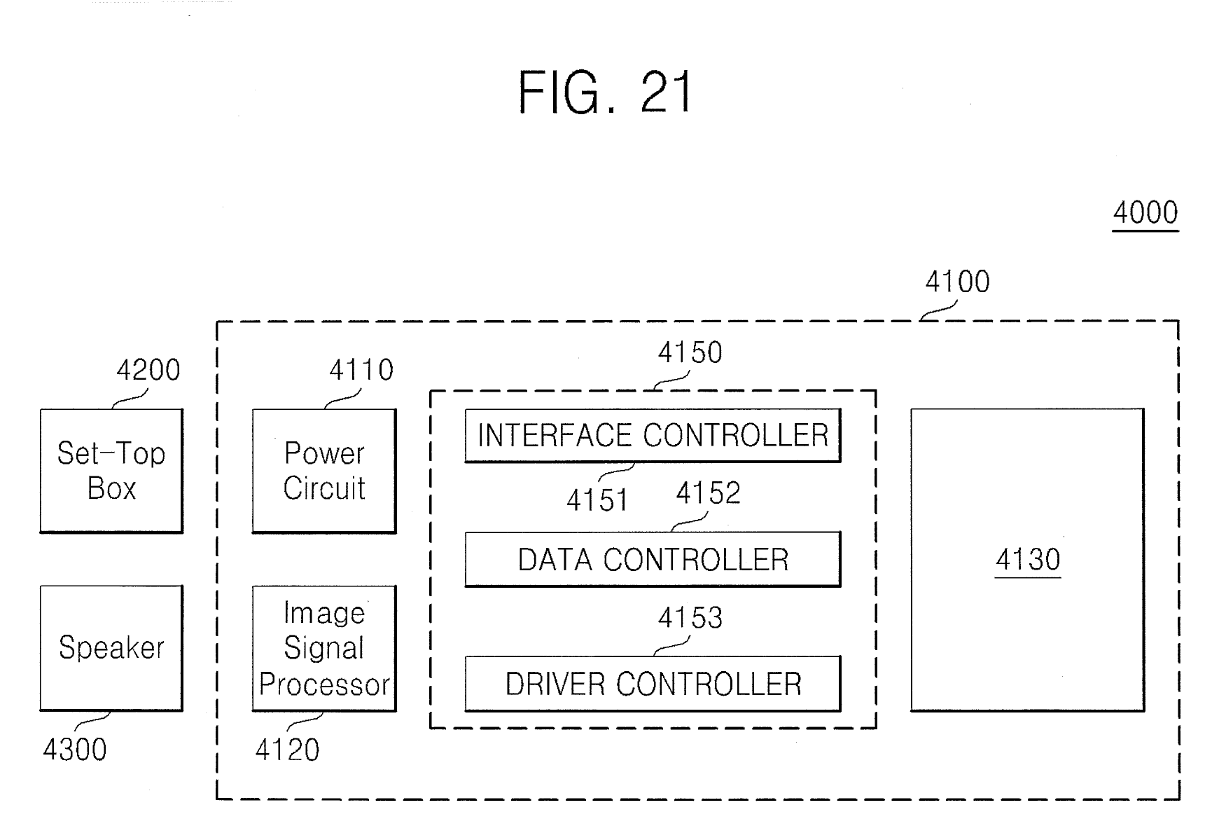

FIG. 21 is a block diagram of an electronic system 4000 including a display device 4100 according to some embodiments of the inventive concepts. The electronic system 4000 includes the display device 4100, a set-top box 4200, and a speaker 4300.

The display device 4100 may include a display panel 4130, a power circuit 4110, an image signal processor 4120, and a control unit 4150. The display panel 4130 may be the PDP 21 illustrated in FIG. 1D.

An interface controller 4151 included in the control unit 4150 converts external image data (e.g., RGB data) into grey-level image data using and transmits the grey-level image data to a data controller 4152. The data controller 4152 outputs the data to an output driver. A driver controller 4153 generates pulse signals for controlling the output driver, an X-driver and a Y-driver.

As described above, according to some embodiments of the inventive concepts, spread driving is used in a display device, thereby reducing the level of peak current that occurs when data signals are output simultaneously. In other words, a coupling capacitance generated between adjacent channels is sustained for an increased period of time to alleviate an output voltage of a data driver of a display driver IC (DDI), thereby spreading and reducing the peak current. Therefore, EMI and power consumption caused by the peak current of the data driver can be reduced.

While the inventive concepts have been particularly shown and described with reference to exemplary embodiments thereof, it will be understood by those of ordinary skill in the art that various changes in forms and details may be made therein without departing from the spirit and scope of the inventive concepts as defined by the following claims.

What is claimed is:

1-5. (canceled)

6. A display driver integrated circuit comprising:
a data storage block configured to store data corresponding to each of N data lines in a display device where N is 2 or an integer greater than 2;
a spreading adjustment block configured to adjust output timings of data corresponding to the respective N data lines in a zigzag spreading pattern; and
an output module configured to output output signals based on the data to the N data lines according to the adjusted output timings.

7. The display driver integrated circuit of claim 6, wherein
the data storage block comprises N registers to store the data in response to a control signal; and
the spreading adjustment block comprises a spreading delay-cell array to adjust output timings of the registers in the zigzag pattern.

8. The display driver integrated circuit of claim 7, wherein
the spreading delay-cell array is configured to adjust the output timings for the N data lines by making an output timing for a first one of the N data lines lag behind an output timing for a k-th data line among the N data lines and making an output timing for a second one of the N data lines lead the output timing for the k-th data line; and
a difference between an earliest output timing and a latest output timing for the N data lines is within a desired period of time.

9. The display driver integrated circuit of claim 8, wherein the spreading delay-cell array is configured to repeat changes in output timings to adjust the output timings for the N data lines in the zigzag pattern.

10. The display driver integrated circuit of claim 9, wherein the spreading delay-cell array comprises a plurality of delay cells which delay data of the N data lines according to the respective output timings for the N data lines.

11. The display driver integrated circuit of claim 7, further comprising:
a switch controller configured to generate and output a switch control signal for controlling the output timings for the N data lines,
wherein the spreading delay-cell array comprises a switching circuit comprising N switching elements respectively connected with the registers configured to turn on an output for a first one of the N data lines L times a unit time interval after an output timing for a k-th data line among the N data lines and to turn on an output for a second one of the N data lines M times the unit time interval before the output timing for the k-th data line in response to the switch control signal.

12. The display driver integrated circuit of claim 11, wherein the spreading delay-cell array is configured to repeat changes in output timings to adjust the output timings for the N data lines in the zigzag pattern.

13. The display driver integrated circuit of claim 6, wherein the output module comprises:
a latch circuit configured to latch an output signal for each of the N data lines;
a level shifter configured to shift a level of the latched output signal; and
an output buffer configured to output the shifted output signal to each data line.

14. The display driver integrated circuit of claim 6, wherein
the data storage block comprises N registers configured to store the data in response to a control signal; and wherein
the spreading adjustment block comprises a latch circuit configured to adjust output timings of the N registers in the zigzag pattern according to an adjustment signal and a switch controller configured to generate the adjustment signal for controlling output timings for the N data lines to control the latch circuit.

15. The display driver integrated circuit of claim 14, wherein
the latch circuit is configured to adjust the output timings for the N data lines by latching data in response to the adjustment signal to make an output timing for a first one of the N data lines lag behind an output timing for a k-th data line among the N data lines and is configured to latch data in response to the adjustment signal to make an output timing for a second one of the N data lines lead the output timing for the k-th data line; and
a difference between an earliest output timing and a latest output timing for the N data lines is within a desired period of time.

16. The display driver integrated circuit of claim 15, wherein the output module comprises:
a level shifter configured to shift a level of the latched output signal; and
an output buffer configured to output the shifted output signal to each data line.

17. The display driver integrated circuit of claim 6, wherein the data storage block comprises:
N registers configured to store the data in response to a control signal; and
latch circuits configured to latch each data of the N registers,wherein the spreading adjustment block comprises a spreading delay-cell array configured to adjust output timings of the latch circuits in the zigzag pattern.

18. The display driver integrated circuit of claim 17, wherein
the spreading delay-cell array is configured to adjust the output timings for the N data lines by latching data in response to the adjustment signal to make an output timing for a first one of the N data lines lag behind an output timing for a k-th data line among the N data lines and latching data in response to the adjustment signal to make an output timing for a second one of the N data lines lead the output timing for the k-th data line; and
a difference between an earliest output timing and a latest output timing for the N data lines is within a desired period of time.

19. The display driver integrated circuit of claim 18, wherein the spreading delay-cell array is configured to repeat changes in output timings to adjust the output timings for the N data lines in the zigzag pattern.

20. The display driver integrated circuit of claim 18, wherein the spreading delay-cell array comprises a plurality of delay cells which delay data of the N data lines, according to the respective output timings for the N data lines.

21. The display driver integrated circuit of claim 20, wherein each of the plurality of delay cells comprises at least one of a buffer, an inverter, a transistor and a switching element.

22. A display device comprising:
a display panel comprising N data lines, a plurality of gate lines and a plurality of pixels connected between the N data lines and the respective gate lines where N is 2 or an integer greater than 2;
an output driver configured to drive the N data lines;
a gate driver configured to gate the plurality of gate lines; and
a control circuit configured to control the output driver and the gate driver,
wherein the output driver comprises:
a data storage block configured to store data corresponding to each of the N data lines;
a spreading adjustment block configured to adjust output timings of data corresponding to the respective N data lines in a zigzag spreading pattern; and
an output module configured to output output signals based on the data to the N data lines according to the adjusted output timings.

23. The display device of claim 22 is a liquid crystal display (LCD) device or an organic light emitting diode (OLED) device.

24.-25. (canceled)

26. An output driver comprising:
a data storage block configured to store data from data lines in the output driver;
a spreading adjustment block configured to adjust output timing of data corresponding to the data lines in a zig-zag pattern.

27. The output driver of claim 26 wherein the data storage block is a register array including a plurality of registers.

28. The output driver of claim 26 wherein the zig-zag pattern is defined by a lag time of L*td and a lead time of M*td, wherein L and M are natural numbers, L-M is greater than or equal to 1, and td is a unit time interval.

29. The output driver of claim 26 wherein the spreading block is a spreading delay cell array.

30. The output driver of claim 29 wherein the spreading delay cell array comprises a unit delay element in parallel with fuses, wherein the fuses are originally in a disconnected state and are configured to be connected by application of a current.
